(19) United States
(12) Patent Application Publication
(10) Pub. No.: US 2005/0119151 A1
(43) Pub. Date: Jun. 2, 2005

(54) Textile cleaning agent which is gentle on textiles

(76) Inventors: Konstanze Mayer, Duesseldorf (DE); Theodor Voelkel, Erkrath (DE); Evelyn Langen, Moenchengladbach (DE); Dieter Nickel, Erkrath (DE); Christian Block, Brussels (BE); Berthold Schreck, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 10/963,403

(22) Filed: Oct. 12, 2004

Related U.S. Application Data
(63) Continuation of application No. PCT/EP03/03369, filed on Apr. 1, 2003.

(30) Foreign Application Priority Data
Apr. 10, 2002 (DE) 102 15 602.6

(51) Int. Cl. C11D 3/00

(52) U.S. Cl. 510/476

(57) ABSTRACT

Liquid aqueous and nonaqueous textile-cleaning compositions containing particles of a fuzz-reducing component selected from the group consisting of: a) biological polymers, b) hydrogels, c) synthetic polymers and d) silicone emulsions, wherein not less than 90% of the particles of a fuzz-reducing components a), b) or c) have a particle size of less than 100 μm, and wherein a fuzz-reducing component selected from d) has an average droplet size below 50 μm.

### CROSS REFERENCE TO RELATED APPLICATIONS

This application is a continuation under 35 U.S.C. § 365(c) and 35 U.S.C. § 120 of international application PCT/EP03/03369, filed Apr. 1, 2003. This application also claims priority under 35 U.S.C. § 119 of DE 102 15 602.6, filed Apr. 10, 2002, which is incorporated herein by reference in its entirety.

### BACKGROUND OF THE INVENTION

This invention concerns a liquid textile-cleaning agent, a mild-action laundry detergent composition, a liquid laundry detergent composition and also a nonaqueous liquid laundry detergent composition comprising at least one fuzz-reducing component. This invention further concerns the use of fuzz-reducing components in liquid textile-cleaning compositions and also the use of mild-action laundry detergent compositions, liquid laundry detergent compositions and nonaqueous liquid laundry detergent compositions to reduce fuzzing and pilling of textile fabrics. This invention further concerns a process for reducing fuzzing.

State of the art textile-cleaning asks a lot of the textiles to be cleaned. Frequent washing of garments in a washing machine and subsequent drying in a tumble dryer is associated with severe mechanical stress for the fabric. Forces of friction frequently lead to damage on the textile fabric, as evidenced by fuzzing and pilling. Each washing and drying operation as well as the wearing of the garments causes further detachment and/or breakage of tiny fibers on the surface of the textile fabric. Conventional textile-cleaning compositions are unable to reduce this damage to the fabric or merely try to remove existing damage to textiles.

WO 99/16956 A1 describes the removal of fuzzballs or pills by using cellulases. Cellulases digest microfibers protruding from the textile fabrics and thus ensure a smooth and therefore pill-free textile surface.

The present invention accordingly has for its object to reduce the fuzzing and pilling of textile fabrics, more particularly to reduce fuzzing and pilling during textile-cleaning.

It has now been found that, surprisingly, the use of certain fuzz-reducing components in textile-cleaning compositions appreciably reduces the fuzzing and pilling of textile fabrics.

### DESCRIPTION OF THE INVENTION

The present invention accordingly provides in a first embodiment a liquid textile-cleaning composition comprising at least one fuzz-reducing component where at least 90% of the particles are less than 100 μm in size, selected from the group of
a) biological polymers and/or
b) hydrogels and/or
c) synthetic polymers and/or
   selected from the group of silicone emulsions having an average droplet size below 50 μm.

This invention provides in a second embodiment a mild-action laundry detergent composition comprising at least one fuzz-reducing component where at least 90% of the particles are less than 100 μm in size, selected from the group of
a) biological polymers and/or
b) hydrogels and/or
c) synthetic polymers and/or
   selected from the group of silicone emulsions having an average droplet size below 50 μm and further comprising at least one softener component.

This invention provides in a third embodiment a liquid laundry detergent composition comprising at least one fuzz-reducing component where at least 90% of the particles are less than 100 μm in size, selected from the group of
a) biological polymers and/or
b) hydrogels and/or
c) synthetic polymers and/or
   selected from the group of silicone emulsions having an average droplet size below 50 μm and also anionic surfactants in amounts up to 30% by weight, each percentage being based on the entire composition.

This invention provides in a fourth embodiment a nonaqueous liquid laundry detergent composition comprising at least one fuzz-reducing component where at least 90% of the particles are less than 100 μm in size, selected from the group of
a) biological polymers and/or
b) hydrogels and/or
c) synthetic polymers and/or
   selected from the group of silicone emulsions having an average droplet size below 50 μm and also nonionic surfactants in an amount up to 35% by weight, each percentage being based on the entire composition.

As used herein, mild-action laundry detergent compositions are textile-cleaning compositions which condition as well as clean the textile fabric. Conditioning for the purposes of this invention refers to the treatment of textile fabrics and yarns with a coating composition. Conditioning endows the textiles with positive properties, such as for example an improved softness, an enhanced brightness of luster and color, a scent refreshening, a reduction in wrinkling and in propensity to build up a static charge, and also easier ironing. Conditioning in the context of this invention further leads to a textile-preserving benefit, detectable by reduced fuzzing and pilling. Mild-action laundry detergent compositions are preferentially used for cleaning sensitive textiles, such as for example linen, wool, silk or cotton.

Liquid laundry detergent compositions referred to herein are textile-cleaning compositions which are liquid or gel-like at 20° C. and can be put to universal use.

Nonaqueous liquid laundry detergent compositions referred to herein are liquid or gel-like textile-cleaning compositions which have a low water content and can be packed in portions in water-soluble envelopes.

As used herein, “nonaqueous” refers to compositions which comprise minimal if any amount of free water, i.e., water not bound as water of crystallization or in some other way. Since even nonaqueous solvents and raw materials (especially those of technical-grade quality) contain a certain amount of water, completely water-free compositions can only be produced on an industrial scale at huge cost and inconvenience. The “nonaqueous” compositions of the present invention thus tolerate low levels of free water which are below 15% by weight, preferably below 10% by weight and more preferably below 5% by weight, each percentage being based on the ready-produced composition.

The present invention's liquid textile-cleaning compositions or mild-action laundry detergent compositions or liquid laundry detergent compositions or nonaqueous liquid laundry detergent compositions include as an essential component at least one fuzz-reducing component where at least 90% of the particles are less than 100 μm in size, selected from the group of
a) biological polymers and/or
b) hydrogels and/or
c) synthetic polymers and/or
   selected from the group of silicone emulsions having an average droplet size below 50 μm.

Fuzz-reducing components are present in the liquid textile-cleaning compositions or mild-action laundry detergent compositions or liquid laundry detergent compositions or nonaqueous liquid laundry detergent compositions as finely divided polymeric particles or polymeric emulsions or polymeric dispersions which possess an affinity for textile fabrics or fibers. In a preferred embodiment the fuzz-reducing components are present as water-insoluble polymers. It is particularly preferable, because of their good biodegradability and their excellent fuzz-reducing performance, for the fuzz-reducing components to be selected from the group of biological polymers. Biological polymers in the context of this invention also include polymers which are only partly biological or biotechnological in origin. However, preference is given to biological polymers where not less than 60%, preferably not less than 80% and especially not less than 90% of the molecular weight is biological or biotechnological in origin. Particularly preferred biological polymers are selected from the group of celluloses. Microcrystalline cellulose of natural origin, for example Arbocel® BE 600-10, Arbocel® BE 600-20 and Arbocel® BE 600-30 ex Rettenmaier, or of biotechnological origin, for example Cellulon® ex Kelco, are extremely preferred. Microbiologically fermented celluloses, as described in U.S. Pat. No. 6,329,192 B1 for example, are likewise useful as a fuzz-reducing component.

Cellulose derivatives are likewise useful as fuzz-reducing components. Examples are alkylated and/or hydroxyalkylated polysaccharides, cellulose ethers, for example hydroxypropylmethylcellulose (HPMC), ethyl-(hydroxyethyl)cellulose (EHEC), hydroxypropylcellulose (HPC), methylcellulose (MC), propylcellulose (PC), carboxymethylmethylcellulose (CMMC), hydroxybutylcellulose (HBC), hydroxybutylmethylcellulose (HBMC), hydroxyethylcellulose (HEC), hydroxyethylcarboxymethyl-cellulose (HECMC), hydroxyethylethylcellulose (HEEC), hydroxypropylcellulose (HPC), hydroxypropylcarboxy-methylcellulose (HPCMC), hydroxyethylmethylcellulose (HEMC), methylhydroxyethylcellulose (MHEC), methyl-hydroxyethylpropylcellulose (MHEPC) and their mixtures, of which methylcellulose, methylhydroxyethylcellulose and methylhydroxypropylcellulose, hydroxypropylcellulose and also the lightly ethoxylated MC or mixtures thereof are preferred.

Further example are mixtures of cellulose ethers with carboxymethylcellulose (CMC).

It will be advantageous with regard to fuzzing and also with regard to the absorption/application characteristics of the cellulose derivatives for not less than 90% of the particles to be less than 100 μm, preferably less than 50 μm and more preferably less than 20 μm in size.

Useful fuzz-reducing components further include hydrogels, and hydrogels of biological polymers are particularly preferred. Since hydrogels are water-containing systems based on hydrophilic but water-insoluble polymers in the form of a three-dimensional network, the particles on the textile surface will be significantly smaller after the drying operation in that they generally will possess just one tenth or less of their original volume. The tiny particles are thus no longer detectable by the consumer's naked eye.

Useful hydrogel dispersions include all hydrogels in finely particular form. In the case of particularly suitable hydrogels of this kind not less than 90% of the particles are less than 100 μm, preferably less than 50 μm and more preferably less than 20 μm in size. Hydrogels where not less than 90% of the particles are less than 500 nm in size are particularly useful. Useful hydrogels include natural polymers such as for example agarose, gelatin, curdlan, alginates, pectinates, carageenans, chitosans.

The absorption/application characteristics of hydrogel particles during the textile-cleaning operation can additionally be improved through their cationic modification.

Networks are chiefly formed through covalent bonds or through electrostatic, hydrophobic or dipole-dipole interactions.

The production of micro- and nanoscale hydrogels is state of the art and has already been described in numerous publications.

Nanoscale hydrogel particles can be formed through microemulsion polymerization of a mostly emulsifier-stabilized water/oil emulsion by homogenization using high-pressure homogenizers or rotor-stator homogenizers. The dispersed polymers or monomers reside in the aqueous phase.

It is further possible to use fuzz-reducing components selected from the group of synthetic polymers, such as for example polyacrylates, polymethacrylates, polyacrylamides or polymethacrylamides, polyurethanes, polyvinylpyrrolidones, polyvinyl alcohols, polyvinyl acetate and/or their partial hydrolyzates or their copolymers.

Synthetic polymers can be included as finely divided powders or dispersions in the compositions of the present invention or else, in a preferred embodiment, be in the form of hydrogels,

Polycarboxylates have been determined to be particularly useful. Polycarboxylates are for example alkali metal salts of polyacrylic acid or polymethacrylic acid, for example those having a relative molecular mass in the range from 500 to 1 000 000 g/mol and preferably in the range from 1000 to 70 000 g/mol.

Useful polymers are in particular polyacrylates, the molar mass of which is preferably in the range from 12 000 to 30 000 g/mol.

It is further possible to use copolymeric polycarboxylates, especially those of acrylic acid with methacrylic acid or of acrylic acid or methacrylic acid with maleic acid. Copolymers of acrylic acid with maleic acid where the acrylic acid content is in the range from 50% to 90% by weight and the maleic acid content is in the range from 50% to 10% by weight will be found particularly useful. Their relative molar mass, based on free acids, is generally in the range from 2000 to 70 000 g/mol, preferably in the range from 15 000 to 50 000 g/mol and especially in the range from 30 000 to 40 000 g/mol.

(Co)polymeric polycarboxylates can be used either as a powder or an aqueous solution. In commerce, the preferred products are either present in the form of aqueous solutions having solids contents in the range from 30% to 40% for example, or spray-dried powders having a solids content of 90% by weight for example. Examples of useful products are the Norasol® range and the Acrysol® range from BASF and Rohm and Haas.

Fuzz reduction performance here too has been found to benefit from the preferably water-insoluble polymers being in a finely divided form. Not less than 90% of the particles are preferably less than 100 μm, more preferably less than 50 μm and even more preferably less than 20 μm in size.

Silicone oils are a further important group of fuzz-reducing components.

The following silicone oils having the formulae I to III have been found to be particularly useful components: 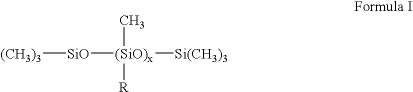
where R is phenyl or C₁-C₅-alkyl and particularly preferably methyl and x is in the range from 5 to 100 000. 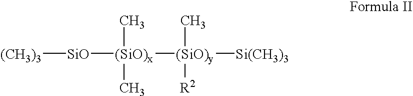
where R² is linear or branched alkyl of 6 to 50 carbon atoms and the attachment to the silicon atom is through an Si—O—C or Si—C bond, or a linear or branched aminoalkyl radical where x is in the range from 0 to 10 000 and y is in the range from 1 to 10 000. 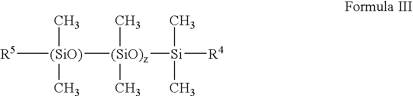
where R⁴ and R⁵ independently represent linear or branched alkyl groups having 6 to 50 carbon atoms. Attachment to the silicon atoms is through C—Si or C—O—Si bonds. z is between 1 and 10 000. Amino-functionalized silicones, such as aminopolydimethylsiloxanes for example, are particularly useful. Silicone oil derivatives may preferably also bear ammonium groups, since these enhance the affinity for textile fabrics and yarns.

Silicone oils are advantageously present as emulsions in which the average droplet size is below 50 μm.

The fuzz components are present in the conditioning compositions of the present invention in amounts from 0.005% to 15% by weight, preferably from 0.01% to 10% by weight, more preferably from 0.1% to 7% by weight and especially from 0.5% to 5% by weight, each percentage being based on the entire composition.

In a preferred embodiment the present invention's liquid textile-cleaning compositions or mild-action laundry detergent compositions or liquid laundry detergent compositions or nonaqueous liquid laundry detergent compositions further comprise nonionic surfactants. The use of nonionic surfactants not only boosts the washing performance of the compositions according to the present invention but additionally augments the dispersion and homogeneous distribution of the fuzz-reducing component or components.

Nonionic surfactants used are preferably alkoxylated, advantageously ethoxylated and/or propoxylated, especially primary alcohols having preferably 8 to 18 carbon atoms and on average from 1 to 12 mol of ethylene oxide (EO) and/or from 1 to 10 mol of propylene oxide (PO) per mole of alcohol. Particular preference is given to C₈-C₁₆-alcohol alkoxylates, advantageously ethoxylated and/or propoxylated C₁₀-C₁₅-alcohol alkoxylates, especially C₁₂-C₁₄-alcohol alkoxylates, having a degree of ethoxylation between 2 and 10 and preferably between 3 and 8 and/or a degree of propoxylation between 1 and 6 and preferably between 1.5 and 5. The alcohol radical may preferably be linear or more preferably methyl branched in 2-position or contain linear and methyl-branched radicals in admixture, as are commonly present in oxo alcohol radicals. In particular, however, preference is given to alcohol ethoxylates containing linear radicals from alcohols of natural origin having 12 to 18 carbon atoms, e.g., from coconut, palm, tallow fatty or oleyl alcohol and on average from 2 to 8 EO per mole of alcohol. Preferred ethoxylated alcohols include, for example, C₁₂₋₁₄ alcohols containing 3 EO or 4 EO, C₉₋₁₁ alcohols containing 7 EO, C₁₃₋₁₅ alcohols containing 3 EO, 5 EO, 7 EO or 8 EO, C₁₂₋₁₈ alcohols containing 3 EO, 5 EO or 7 EO, and mixtures thereof, such as mixtures of C₁₂₋₁₄ alcohol containing 3 EO and C₁₂₋₁₈ alcohol containing 5 EO. The stated degrees of ethoxylation and propoxylation represent statistical mean values, which for a specific product may be an integer or a fraction. Preferred alcohol ethoxylates and propoxylates have a narrowed homolog distribution (narrow range ethoxylates/propoxylates, NREs/NRPs). In addition to these nonionic surfactants it is also possible to use fatty alcohols containing more than 12 EO. Examples thereof are tallow fatty alcohols containing 14 EO, 25 EO, 30 EO or 40 EO.

It is further possible to use alkoxylated amines, advantageously ethoxylated and/or propoxylated, especially primary and secondary amines having preferably 1 to 18 carbon atoms per alkyl chain and on average 1 to 12 mol of ethylene oxide (EO) and/or 1 to 10 mol of propylene oxide (PO) per mole of amine.

Capped alkoxylated fatty amines and fatty alcohols will be found particularly advantageous, especially for use in the present invention's nonaqueous formulations. In capped fatty alcohol alkoxylates and fatty amine alkoxylates, the terminal hydroxyl groups of the fatty alcohol alkoxylates and fatty amine alkoxylates are etherified with C₁-C₂₀-alkyl groups, preferably methyl or ethyl groups.

Useful nonionic surfactants further include alkylglycosides of the general formula RO(G)ₓ, for example as compounds, particularly with anionic surfactants, where R is a primary straight-chain or methyl-branched (in the 2-position especially) aliphatic radical having 8 to 22 and preferably 12 to 18 carbon atoms and G represents a glycose unit having 5 or 6 carbon atoms, preferably glucose. The degree of oligomerization x, which indicates the distribution of monoglycosides and oligoglycosides, is any desired number between 1 and 10; preferably, x is in the range from 1.2 to 1.4.

A further class of preferred nonionic surfactants, which are used either as sole nonionic surfactant or in a combination with other nonionic surfactants, are alkoxylated, preferably ethoxylated or ethoxylated and propoxylated, fatty acid alkyl esters, preferably having 1 to 4 carbon atoms in the alkyl chain, especially fatty acid methyl esters as described for example in Japanese patent application JP 58/217598 or those which are preferably prepared by the process described in the international patent application WO-A-90/13533.

Further suitable surfactants include those known as gemini surfactants. This term is used generally to refer to those compounds which possess two hydrophilic and two hydrophobic groups per molecule. These groups are generally separated from one another by what is known as a spacer. This spacer is generally a carbon chain, which should be long enough to keep the hydrophilic groups at a distance sufficient to allow them to act independently of one another. Surfactants of this kind are generally notable for an unusually low critical micelle concentration and the ability to reduce greatly the surface tension of water. In exceptional cases, however, the expression gemini surfactants is used to embrace not only dimeric but also trimeric surfactants.

Examples of suitable gemini surfactants are sulfated hydroxy mixed ethers in accordance with German patent application DE-A-43 21 022 or dimer alcohol bis- and trimer alcohol tris-sulfates and ether sulfates in accordance with international patent application WO-A-96/23768. Capped dimeric and trimeric mixed ethers in accordance with German patent application DE-A-195 13 391 are notable in particular for their bi- and multifunctionality. These capped surfactants possess good wetting properties and are low-sudsing, making them particularly suitable for use in machine washing or cleaning processes.

However, it is also possible to use gemini-polyhydroxy fatty acid amides or polypolyhydroxy fatty acid amides, as described in international patent applications WO-A-95/19953, WO-A-95/19954, and WO-A-95/19955.

Further suitable surfactants are polyhydroxy fatty acid amides of the formula 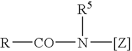
where RCO is an aliphatic acyl radical having 6 to 22 carbon atoms, R⁵ is hydrogen or an alkyl or hydroxyalkyl radical having 1 to 4 carbon atoms, and [Z] is a linear or branched polyhydroxyalkyl radical having 3 to 10 carbon atoms and 3 to 10 hydroxyl groups. The polyhydroxy fatty acid amides are known materials, typically obtainable by reduction amination of a reducing sugar with ammonia, an alkylamine or an alkanolamine and subsequent acylation with a fatty acid, a fatty acid alkyl ester or a fatty acid chloride.

The group of the polyhydroxy fatty acid amides also includes compounds of the formula 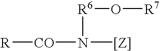
where R is a linear or branched alkyl or alkenyl radical having 7 to 12 carbon atoms, R⁶ is a linear, branched or cyclic alkyl radical or an aryl radical having 2 to 8 carbon atoms and R⁷ is a linear, branched or cyclic alkyl radical or an aryl radical or an oxyalkyl radical having 1 to 8 carbon atoms, preference being given to C₁₋₄-alkyl radicals or phenyl radicals, and [Z] is a linear polyhydroxyalkyl radical whose alkyl chain is substituted by at least two hydroxyl groups, or alkoxylated, preferably ethoxylated or propoxylated, derivatives of said radical.

[Z] is preferably obtained by reductive amination of a sugar such as glucose, fructose, maltose, lactose, galactose, mannose, or xylose. The N-alkoxy- or N-aryloxy-substituted compounds may then be converted to the desired polyhydroxy fatty acid amides, for example, in accordance with the teaching of international patent application WO 95/07331 by reaction with fatty acid methyl esters in the presence of an alkoxide as catalyst.

The liquid textile-cleaning compositions in a preferred embodiment comprise alkoxylated fatty alcohols, more preferably ethoxylated and/or propoxylated fatty alcohols.

Mild-action laundry detergent compositions advantageously utilize nonionic surfactants selected from the group of alkoxylated fatty alcohols and/or alkylglyco-sides, especially mixture of alkoxylated fatty alcohols and alkylglycosides.

The mild-action laundry detergent compositions of the present invention in a preferred embodiment comprise nonionic surfactants in amounts up to 30% by weight, preferably in the range from 5% to 25% by weight and more preferably in the range from 10% to 20% by weight, each percentage being based on the entire composition.

The liquid laundry detergent compositions of the present invention in a preferred embodiment comprise nonionic surfactants in amounts up to 30% by weight, preferably in the range from 5% to 20% by weight and especially in the range from 10% to 15% by weight, each percentage being based on the entire composition.

The nonaqueous liquid laundry detergent compositions of the present invention in a preferred embodiment comprise nonionic surfactants in an amount up to 35% by weight and preferably in the range from 15% to 25% by weight, each percentage being based on the entire composition.

The present invention's liquid textile-cleaning compositions or mild-action laundry detergent compositions or liquid laundry detergent compositions or nonaqueous liquid laundry detergent compositions further comprise anionic surfactants in a preferred embodiment. The use of anionic surfactants distinctly enhances the soil-detaching performance of the present invention's compositions during the washing operation without significantly impairing the absorption/application of the fuzz-reducing components.

Useful anionic surfactants include for example those of the sulfonate type and of the sulfate type. Preferred surfactants of the sulfonate type are C₉₋₁₃-alkylbenzenesulfonates, olefinsulfonates, i.e. mixtures of alkenesulfonates and hydroxyalkanesulfonates and also disulfonates, as are obtained, for example, from C₁₂₋₁₈-monoolefins having a terminal or internal double bond by sulfonating with gaseous sulfur trioxide followed by alkaline or acidic hydrolysis of the sulfonation products. Also suitable are alkanesulfonates, which are obtained from C₁₂₋₁₈-alkanes, for example by sulfochlorination or sulfoxidation with subsequent hydrolysis or neutralization, respectively. Likewise suitable, in addition, are the esters of α-sulfo fatty acids (ester sulfonates), e.g. the α-sulfonated methyl esters of hydrogenated coconut, palm kernel or tallow fatty acids.

Further suitable anionic surfactants are sulfated fatty acid glycerol esters which are the monoesters, diesters and triesters, and mixtures thereof, as obtained in the preparation by esterification of a monoglycerol with from 1 to 3 mol of fatty acid or in the transesterification of triglycerides with from 0.3 to 2 mol of glycerol. Preferred sulfated fatty acid glyceryl esters are sulfation products of saturated fatty acids of 6 to 22 carbon atoms, e.g., of capric acid, caprylic acid, capric acid, myristic acid, lauric acid, palmitic acid, stearic acid or behenic acid.

Preferred alk(en)yl sulfates are the alkali metal salts, and especially the sodium salts, of the sulfuric monoesters of C₁₂-C₁₈ fatty alcohols, examples being those of coconut fatty alcohol, tallow fatty alcohol, lauryl, myristyl, cetyl or stearyl alcohol, or of C₁₀-C₂₀ oxo alcohols, and those monoesters of secondary alcohols of this chain length. Preference is also given to alk(en)yl sulfates of said chain length which contain a synthetic straight-chain alkyl radical prepared on a petrochemical basis, these sulfates possessing degradation properties similar to those of the corresponding compounds based on fatty-chemical raw materials. From a detergents standpoint, C₁₂-C₁₆-alkyl sulfates and C₁₂-C₁₅-alkyl sulfates, and also C₁₄-C₁₅ alkyl sulfates, are preferred. In addition, 2,3-alkyl sulfates, which may for example be prepared in accordance with U.S. Pat. No. 3,234,258 or U.S. Pat. No. 5,075,041 and obtained as commercial products from Shell Oil Company under the name DAN®, are suitable anionic surfactants.

Also suitable are the sulfuric monoesters of the straight-chain or branched C₇₋₂₁ alcohols ethoxylated with from 1 to 6 mol of ethylene oxide, such as 2-methyl-branched C₉₋₁₁ alcohols containing on average 3.5 mol of ethylene oxide (EO) or C₁₂₋₁₈ fatty alcohols containing from 1 to 4 EO which are known as fatty alcohol ether sulfates, and are particularly preferred anionic surfactants in this invention.

Preferred anionic surfactants further include the salts of alkylsulfosuccinic acid, which are also referred to as sulfosuccinates or as sulfosuccinic esters and which constitute the monoesters and/or diesters of sulfosuccinic acid with alcohols, preferably fatty alcohols and especially ethoxylated fatty alcohols. Preferred sulfosuccinates comprise C₈₋₁₈ fatty alcohol radicals or mixtures thereof. Especially preferred sulfosuccinates contain a fatty alcohol radical derived from ethoxylated fatty alcohols which themselves represent nonionic surfactants. Particular preference is given in turn to sulfosuccinates whose fatty alcohol radicals are derived from ethoxylated fatty alcohols having a narrowed homolog distribution. Similarly, it is also possible to use alk(en)ylsuccinic acid containing preferably 8 to 18 carbon atoms in the alk(en)yl chain, or salts thereof.

Further suitable anionic surfactants are, in particular, soaps. Suitable soaps include saturated fatty acid soaps, such as the salts of lauric acid, myristic acid, palmitic acid, stearic acid, hydrogenated erucic acid and behenic acid, and, in particular, mixtures of soaps derived from natural fatty acids, e.g., coconut, palm kernel, or tallow fatty acids.

The anionic surfactants, including the soaps, may be present in the form of their sodium, potassium or ammonium salts and also as soluble salts of organic bases, such as mono-, di- or triethanolamine. Preferably, the anionic surfactants are in the form of their sodium or potassium salts, in particular in the form of the sodium salts. The nonaqueous liquid laundry detergent compositions of the present invention, however, preferably utilize the ammonium salts, especially the salts of organic bases, as for example of isopropylamine.

A further class of anionic surfactants is the class of ether carboxylic acids which is obtainable by reacting fatty alcohol ethoxylates with sodium chloroacetate in the presence of basic catalysts. Ether carboxylic acids have the general formula: R¹⁰ O—(CH₂—CH₂—O)ₚ—CH₂—COOH where R¹⁰=C₁-C₁₈ and p=0.1 to 20. Ether carboxylic acids are water hardness insensitive and have excellent surfactant properties. Preparation and use are described for example in Seifen, Öle, Fette, Wachse 101, 37 (1975); 115, 235 (1989) and Tenside Deterg. 25, 308 (1988).

The textile-cleaning compositions of the present invention in a preferred embodiment comprise anionic surfactants, preferably selected from the group of fatty alcohol sulfates and/or fatty alcohol ether sulfates and/or alkylbenzenesulfonates and/or soaps.

The mild-action laundry detergent compositions of the present invention in a preferred embodiment comprise anionic surfactants in amounts below 10% by weight, preferably below 5% by weight and especially below 1% by weight, each percentage being based on the entire composition.

The liquid laundry detergent compositions of the present invention in a preferred embodiment comprise anionic surfactants in amounts up to 30% by weight, preferably up to 25% by weight, more preferably in the range from 5% to 20% by weight and especially in the range from 8% to 15% by weight, each percentage being based on the entire composition.

The nonaqueous liquid laundry detergent compositions of the present invention in a preferred embodiment comprise anionic surfactants in amounts up to 60% by weight, preferably in the range from 20% to 50% by weight and especially in the range from 30% to 45% by weight, each percentage being based on the entire composition.

Furthermore, the present invention's liquid textile-cleaning compositions or mild-action laundry detergent compositions or liquid laundry detergent compositions or nonaqueous liquid laundry detergent compositions may additionally comprise complexing agents in a preferred embodiment. Complexing agents improve the stability of the compositions and protect for example against heavy metal catalyzed decomposition of certain ingredients of detersive formulations.

The group of complexing agents includes for example the alkali metal salts of nitrilotriacetic acid (NTA) and its derivatives and also alkali metal salts of anionic polyelectrolytes such as polyacrylates, polymaleates and polysulfonates. Useful complexing agents further include low molecular weight hydroxy carboxylic acids such as citric acid, tartaric acid, malic acid or gluconic acid and their salts. These preferred compounds include in particular organophosphonates such as for example 1-hydroxyethane-1,1-diphosphonic acid (HEDP), aminotri(methylenephosphonic acid) (ATMP), diethylenetriaminepenta(methylenephosphonic acid) (DTPMP or DETPMP) and also 2-phosphonobutane-1,2,4-tricarboxylic acid (PBS-AM), which are usually used in the form of their ammonium or alkali metal salts.

In a preferred embodiment of the present invention's liquid textile-cleaning compositions or mild-action laundry detergent compositions or liquid laundry detergent compositions or nonaqueous liquid laundry detergent compositions the complexing agents are present in an amount up to 10% by weight, preferably from 0.01% to 5% by weight, more preferably from 0.1% to 2% by weight and especially from 0.3% to 1.0% by weight, each percentage being based on the entire composition.

Furthermore, the present invention's liquid textile-cleaning compositions or mild-action laundry detergent compositions or liquid laundry detergent compositions or nonaqueous liquid laundry detergent compositions may additionally comprise enzymes in a preferred embodiment.

Enzymes augment wash processes in various ways, especially in relation to the removal of difficult-to-bleach soils, such as protein stains.

Useful enzymes include in particular those from the class of the hydrolases such as the proteases, esterases, lipases or lipolytically acting enzymes, amylases, cellulases or other glycosyl hydrolases and mixtures thereof. All these hydrolases contribute in the wash to the removal of stains such as proteinaceous, greasy or starchy stains and grayness. Cellulases and other glycosyl hydrolases may in addition, through the removal of pilling and microfibrils, contribute to textile color preservation and softness enhancement. Similarly, oxyreductases can be used for bleaching or for inhibiting dye transfer. Enzymatic actives obtained from bacterial strains or fungi such as Bacillus subtilis, Bacillus licheniformis, Streptomyceus griseus and Humicola insolens are particularly useful. Preference is given to proteases of the subtilisin type and especially proteases obtained from Bacillus lentus. Enzyme mixtures, for example of protease and amylase or of protease and lipase or lipolytically acting enzymes or of protease and cellulase or of cellulase and lipase or lipolytically acting enzymes or of protease, amylase and lipase or of lipolytically acting enzymes or protease, lipase or lipolytically acting enzymes and cellulase, but especially protease and/or lipase-containing mixtures or mixtures with lipolytically acting enzymes are of particular interest. The familiar cutinases are examples of such lipolytically acting enzymes. Similarly, peroxidases or oxidases will be found useful in some cases. Useful amylases include especially (a-amylases, isoamylases, pullulanases and pectinases. Cellulases used are preferably cellobiohydrolases, endoglucanases and β-glucosidases, also known as cellobiases, and mixtures thereof. Since the various cellulase types differ in CMCase and Avicelase activity, desired activities can be achieved through specific mixtures of the cellulases.

Enzymes may be formed into shaped articles and adsorbed on carriers or embedded in coatings and thus be protected against premature decomposition.

The liquid textile-cleaning compositions of the present invention in a preferred embodiment comprise enzymes, preferably selected from the group of proteases and/or amylases and/or cellulases.

The mild-action laundry detergent compositions of the present invention in a preferred embodiment comprise cellulase, preferably in an amount from 0.005% to 2% by weight, more preferably from 0.01% to 1% by weight and especially from 0.02% to 0.5% by weight, each percentage being based on the entire composition.

The liquid laundry detergent compositions of the present invention in a preferred embodiment comprise protease and/or amylase and more preferably any desired mixtures of protease and amylase.

The nonaqueous liquid detergent compositions of the present invention in a preferred embodiment comprise enzymes, preferably selected from the group of proteases and/or amylases and/or cellulases and more preferably any desired mixtures of proteases, amylases and cellulases.

The viscosity of the present invention's liquid textile-cleaning compositions or mild-action laundry detergent compositions or liquid laundry detergent compositions or nonaqueous liquid laundry detergent compositions is advantageously in the range from 50 to 5000 mPas, more preferably in the range from 50 to 3000 mPas and especially in the range from 500 to 1500 mPas (measured at 20° C. using a rotary viscometer (Brookfield RV, spindle 2) at 20 rpm (rpm: revolutions per minute)).

The present invention's liquid textile-cleaning compositions or mild-action laundry detergent compositions or liquid laundry detergent compositions or nonaqueous liquid laundry detergent compositions comprise one or more solvents in preferred embodiments.

Solvents useful in the compositions of the present invention belong for example to the group of mono- or polyhydric alcohols, alkanolamines or glycol ethers provided they are miscible with water in the stated concentration range. The solvents are preferably selected from ethanol, n-propanol, i-propanol, butanols, glycol, propanediol, butanediol, glycerol, diglycol, propyldiglycol, butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, butoxypropoxypropanol (BPP), dipropylene glycol monomethyl ether, dipropylene glycol monoethyl ether, diisopropylene glycol monomethyl ether, diosopropylene glycol monoethyl ether, methoxytriglycol, ethoxytriglycol, butoxytriglycol, 1-butoxyethoxy-2-propanol, 3-methyl-3-methoxybutanol, propylene glycol t-butyl ether and also mixtures thereof. Some glycol ethers are available under the trade names Arcosolv® (Arco Chemical Co.) or Cellosolv®, Carbitol® or Propasol® (Union Carbide Corp.); these also include for example ButylCarbitol®, HexylCarbitol®, MethylCarbitol® and Carbitol® itself, (2-(2-ethoxy)ethoxy)ethanol. The choice of glycol ether can be readily made by one skilled in the art on the basis of its volatility, water-solubility, weight percentage of the total composition and the like. Pyrrolidone solvents, such as N-alkylpyrrolidones, for example N-methyl-2-pyrrolidone or N-C₈-C₁₂-alkylpyrrolidone, or 2-pyrrolidone, can likewise be used. Glycerol derivatives, especially glycerol carbonate, are further preferred for use as sole solvent or as constituent of a solvent mixture.

Alcohols which can be employed as co-solvents in the present invention include liquid polyethylene glycols having a comparatively low molecular weight, for example polyethylene glycols having a molecular weight of 200, 300, 400 or 600. Useful co-solvents further include other alcohols, for example (a) lower alcohols such as ethanol, propanol, isopropanol and n-butanol, (b) ketones such as acetone and methyl ethyl ketone, (c) C₂-C₄-polyols such as a diol or a triol, for example ethylene glycol, propylene glycol, glycerol or mixtures thereof. 1,2-Octanediol is a particularly preferred diol.

The compositions of the present invention may comprise one or more water-soluble organic solvents in a preferred embodiment. Water-soluble is here to be understood as meaning that an organic solvent referred to is soluble in an aqueous or nonaqueous composition in the amount in which it is included therein.

In a preferred embodiment the conditioning composition of the present invention comprises one or more solvents from the group consisting of C₁- to C₄-monoalcohols, C₂- to C₆-glycols, C₃- to C₁₂-glycol ethers and glycerol, especially ethanol. The present invention's C₃- to C₁₂-glycol ethers comprise alkyl or alkenyl groups having fewer than 10 carbon atoms, preferably up to 8, especially up to 6, more preferably from 1 to 4 and extremely preferably 2 to 3 carbon atoms.

Preferred C₁- to C₄-monoalcohols are ethanol, n-propanol, isopropanol and tert-butanol. Preferred C₂- to C₆-glycols are ethylene glycol, 1,2-propylene glycol, 1,3-propylene glycol, 1,5-pentanediol, neopentyl glycol and 1,6-hexanediol, especially ethylene glycol and 1,2-propylene glycol. Preferred C₃- to C₁₂-glycol ethers are di-, tri-, tetra- and pentaethylene glycol, di-, tri- and tetrapropylene glycol, propylene glycol mono-tert-butyl ether and propylene glycol monoethyl ether and also the solvents having the INCI designations Butoxydiglycol, Butoxyethanol, Butoxyisopropanol, Butoxypropanol, Butyloctanol, Ethoxydiglycol, Ethoxyethanol, Ethyl Hexanediol, Isobutoxypropanol, Isopentyldiol, 3-Methoxybutanol, Methoxyethanol, Methoxyisopropanol and Methoxymethylbutanol.

Particularly preferred solvents are ethanol, 1,2-propylene glycol and dipropylene glycol and also mixtures thereof, especially ethanol and isopropanol.

The mild-action laundry detergent compositions of the present invention comprise in a preferred embodiment up to 95% by weight, more preferably from 20% to 90% by weight and especially from 50% to 80% by weight of one or more solvents, preferably water-soluble solvents and especially water.

The liquid laundry detergent compositions of the present invention comprise in a preferred embodiment up to 90% by weight, more preferably from 20% to 85% by weight and especially from 50% to 80% by weight of one or more solvents, preferably water-soluble solvents and especially water.

The nonaqueous liquid laundry detergent compositions of the present invention comprise in a preferred embodiment organic solvents in amounts up to 50% by weight, preferably up to 45% by weight and especially in the range from 20% to 40% by weight, each percentage being based on the entire composition.

As well as the aforementioned components, the present invention's liquid textile-cleaning compositions or mild-action laundry detergent compositions or liquid laundry detergent compositions or nonaqueous liquid laundry detergent compositions may comprise softener components. Especially mild-action laundry detergent compositions have been found to benefit greatly from the use of additional softener components. Softener components provide conditioning to textile fabrics in the course of the wash cycle, so that no additional conditioning rinse cycle is required. The use of softener components is advantageous especially when washing sensitive textiles, for example silk, wool or linen, which are low temperature washed and ironed. Softener components make textiles easier to iron and reduce their static charge buildup.

Examples of fabric-softening components are quaternary ammonium compounds, cationic polymers and emulsifiers as used in hair care compositions and also in textile-coating compositions.

Suitable examples are quaternary ammonium compounds of the formulae (I) and (II) 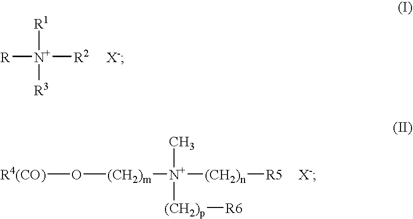
where, in (I), R and R¹ each represent an acyclic alkyl radical of 12 to 24 carbon atoms, R² represents a saturated C₁-C₄-alkyl or hydroxyalkyl radical, R³ is either the same as R, R¹ or R² or represents an aromatic radical. X⁻ represents either a halide, methosulfate, methophosphate or phosphate ion and also mixtures thereof. Examples of cationic compounds of the formula (I) are didecyldimethylammonium chloride, ditallowdimethylammonium chloride or dihexadecylammonium chloride.

Compounds of the formula (II) are known as ester quats. Ester quats are notable for excellent biodegradability. In the formula (II), R⁴ represents an aliphatic alkyl radical of 12 to 22 carbon atoms which has 0, 1, 2 or 3 double bonds; R⁵ represents H, OH or O(CO)R⁷, R⁶ represents H, OH or O(CO)R⁸ independently of R⁵, with R⁷ and R⁸ each being independently an aliphatic alkyl radical of 12 to 22 carbon atoms which has 0, 1, 2 or 3 double bonds. m, n and p are each independently 1, 2 or 3. X⁻ may be either a halide, methosulfate, methophosphate or phosphate ion and also mixtures thereof. Preference is given to compounds where R⁵ is O(CO)R⁷ and R⁴ and R⁷ are alkyl radicals having 16 to 18 carbon atoms. Particular preference is given to compounds wherein R⁶ also represents OH. Examples of compounds of the formula (II) are methyl-N-(2-hydroxyethyl)-N,N-di(tallowacyloxyethyl)ammonium methosulfate, bis-(palmitoyl)ethylhydroxyethylmethylammonium methosulfate or methyl-N,N-bis(acyloxyethyl)-N-(2-hydroxyethyl)ammonium methosulfate. In quaternized compounds of the formula (II) which comprise unsaturated alkyl chains, preference is given to acyl groups whose corresponding fatty acids have an iodine number between 5 and 80, preferably between 10 and 60 and especially between 15 and 45 and also a cis/trans isomer ratio (in % by weight) of greater than 30:70, preferably greater than 50:50 and especially greater than 70:30. Commercially available examples are the methylhydroxyalkyldialkoyloxyalkylammonium methosulfates marketed by Stepan under the Stepantex® brand or the Cognis products appearing under Dehyquart® or the Goldschmidt-Witco products appearing under Rewoquat®. Preferred compounds further include the diester quats of the formula (III) which are obtainable under the name Rewoquat® W 222 LM or CR 3099 and provide stability and color protection as well as softness. 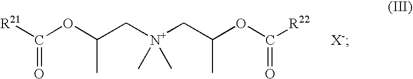
where R²¹ and R²² each independently represent an aliphatic radical of 12 to 22 carbon atoms which has 0, 1, 2 or 3 double bonds.

As well as the quaternary compounds described above it is also possible to use other known compounds, for example quaternary imidazolinium compounds of the formula (IV) 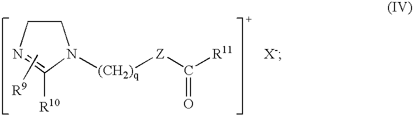
where R⁹ represents H or a saturated alkyl radical having 1 to 4 carbon atoms, R¹⁰ and R¹¹ are each independently an aliphatic, saturated or unsaturated alkyl radical having 12 to 18 carbon atoms, R¹⁰ may alternatively also represent O(CO)R²⁰, R²⁰ being an aliphatic, saturated or unsaturated alkyl radical of 12 to 18 carbon atoms, Z is an NH group or oxygen, X⁻ is an anion and q can assume integral values between 1 and 4.

Useful quaternary compounds are further described by the formula (V) 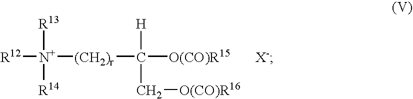
where R¹², R¹³ and R¹⁴ independently represent a C₁₋₄-alkyl, alkenyl or hydroxyalkyl group, R¹⁵ and R¹⁶ each independently represent a C₈₋₂₈-alkyl group and r is a number between 0 and 5.

As well as compounds of the formulae (I) and (II) it is also possible to use short-chain, water-soluble quaternary ammonium compounds, such as trihydroxyethyl-methylammonium methosulfate or alkyltrimethylammonium chlorides, dialkyldimethylammonium chlorides and trialkylmethylammonium chlorides, for example cetyltri-methylammonium chloride, stearyltrimethylammonium chloride, distearyldimethylammonium chloride, lauryldi-methylammonium chloride, lauryldimethylbenzylammonium chloride and tricetylmethylammonium chloride.

Similarly, protonated alkylamine compounds, which have a softening effect, and also the nonquaternized, protonated precursors of cationic emulsifiers are suitable.

Cationic compounds useful in the present invention further include quaternized protein hydrolyzates.

Suitable cationic polymers include the polyquaternium polymers, as in the CTFA Cosmetic Ingredient Dictionary (The Cosmetic, Toiletry and Fragrance, Inc. 1997), in particular the polyquaternium-6, polyquaternium-7, polyquaternium-10 polymers (Ucare Polymer IR 400; Amerchol), also referred to as merquats, polyquaternium-4 copolymers, such as graft copolymers with a cellulose backbone and quaternary ammonium groups which are bonded via allyldimethylammonium chloride, cationic cellulose derivatives, such as cationic guar, such as guar hydroxypropyltriammonium chloride, and similar quaternized guar derivatives (e.g. Cosmedia Guar, manufacturer: Cognis GmbH), cationic quaternary sugar derivatives (cationic alkyl polyglucosides), e.g. the commercial product Glucquat® 100, according to CTFA nomenclature a “Lauryl Methyl Gluceth-10 Hydroxypropyl Dimonium Chloride”, copolymers of PVP and dimethylaminomethacrylate, copolymers of vinylimidazole and vinylpyrrolidone, aminosilicone polymers and copolymers.

It is likewise possible to use polyquaternized polymers (e.g. Luviquat Care from BASF) and also cationic biopolymers based on chitin and derivatives thereof, for example the polymer obtainable under the trade name Chitosan® (manufacturer: Cognis).

Likewise suitable according to the invention are cationic silicone oils, such as, for example, the commercially available products Q2-7224 (manufacturer: Dow Corning; a stabilized trimethylsilylamodimethicone), Dow Corning 929 emulsion (comprising a hydroxyl-amino-modified silicone, which is also referred to as amodimethicone), SM-2059 (manufacturer: General Electric), SLM-55067 (manufacturer: Wacker) Abil®-Quat 3270 and 3272 (manufacturer: Goldschmidt-Rewo; diquaternary polydimethylsiloxanes, quaternium-80) and Siliconquat Rewoquat® SQ 1 (Tegopren® 6922, manufacturer: Goldschmidt-Rewo).

It is likewise possible to use compounds of the formula (VI) 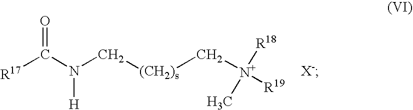
which may be alkylamidoamines in their nonquaternized or, as shown, their quaternized form. R¹⁷ may be an aliphatic alkyl radical having 12 to 22 carbon atoms with 0, 1, 2 or 3 double bonds. s can assume values between 0 and 5. R¹⁸ and R¹⁹ are, independently of one another, each H, C₁₋₄-alkyl or hydroxyalkyl. Preferred compounds are fatty acid amidoamines, such as the stearylamidopropyldimethylamine obtainable under the name Tego Amid® S18, or the 3-tallowamidopropyltrimethylammonium methosulfate obtainable under the name Stepantex® X 9124, which are characterized not only by a good conditioning effect, but also by color-transfer-inhibiting effect and in particular by their good biodegradability. Particular preference is given to alkylated quaternary ammonium compounds in which at least one alkyl chain is interrupted by an ester group and/or amido group, in particular N-methyl-N-(2-hydroxyethyl)-N,N-(ditallowacyloxyethyl)ammonium methosulfate and/or N-methyl-N-(2-hydroxyethyl)-N,N-(palmitoyloxyethyl)ammonium methosulfate.

Nonionic softeners are primarily polyoxyalkylene glycerol alkanoates, as are described in British patent specification GB 2,202,244, polybutylenes, as are described in British patent specification GB 2,199,855, long-chain fatty acids, as are described in EP 13 780, ethoxylated fatty acid ethanolamides, as are described in EP 43 547, alkyl polyglycosides, in particular sorbitan mono-, di- and triesters, as are described in EP 698 140 and fatty acid esters of polycarboxylic acids, as are described in German patent specification DE 2,822,891.

In a preferred embodiment the mild-action laundry detergent compositions of the present invention comprise cationic surfactants, preferably alkylated quaternary ammonium compounds where at least one alkyl chain is interrupted by an ester group and/or amido group.

The use of ester quats of the abovementioned formula II will be found particularly advantageous and effective. Especially ester quats of the formula [(CH₃)₂N⁺(CH₂CH₂OC(O)—R)₂]X⁻ or [(HOCH₂CH₂)(CH₃)N⁺(CH₂CH₂OC(O)—R)₂]X⁻ where R=linear saturated or unsaturated alkyl radical of 11 to 19 and preferably 13 to 17 carbon atoms. In a particularly preferred embodiment the fatty acid residues are tallow fatty acid residues. X⁻ represents either a halide, for example chloride or bromide, methophosphate or phosphate ion, preferably from methosulfate ion, and also mixtures thereof.

Quaternary ammonium compounds of the aforementioned formula V are further preferable.

Especially the combination with ester quats and/or the aforementioned ammonium compounds of the formula V has been determined to provide a particularly intensive fuzz-reducing and/or wrinkle-reducing and also pill-reducing effect, especially when the fuzz-reducing component used is microcrystalline cellulose as described above.

Specifically N-methyl-N-(2-hydroxyethyl)-N,N-(dital-lowacyloxyethyl)ammonium methosulfate or N-methyl-N-(2-hydroxyethyl)-N,N-(dipalmitoylethyl)ammonium methosulfate are preferred.

In a further preferred embodiment the mild-action laundry detergent compositions of the present invention comprise softener component in an amount up to 15% by weight, preferably in the range from 0.1% to 10% by weight, more preferably in the range from 0.5% to 7% by weight and especially in the range from 1% to 3% by weight, each percentage being based on the entire composition.

As well as the aforementioned components, the present invention's liquid textile-cleaning compositions or mild-action laundry detergent compositions or liquid laundry detergent compositions or nonaqueous liquid laundry detergent compositions may comprise pearl luster agents. Pearl luster agents endow textiles with an additional luster and therefore are preferentially used in the mild-action laundry detergent compositions of the present invention.

Useful pearl luster agents include for example: alkylene glycol esters; fatty acid alkanolamides; partial glycerides; esters of polybasic carboxylic acids with or without hydroxyl substitution with fatty alcohols having 6 to 22 carbon atoms; fatty materials, for example fatty alcohols, fatty ketones, fatty aldehydes, fatty ethers and fatty carbonates which together have at least 24 carbon atoms; ring-opening products of olefin epoxides having 12 to 22 carbon atoms with fatty alcohols having 12 to 22 carbon atoms, fatty acids and/or polyols having 2 to 15 carbon atoms and 2 to 10 hydroxyl groups and also mixtures thereof.

Furthermore, the present invention's liquid textile-cleaning compositions or mild-action laundry detergent compositions or liquid laundry detergent compositions or nonaqueous liquid laundry detergent compositions may further comprise thickeners. The use of thickeners in the liquid laundry detergent compositions of the present invention will be particularly advantageous. The use of thickeners in particular in gel-like liquid laundry detergent compositions will boost consumer acceptance. The thickened consistency of the composition simplifies the application of the compositions directly to the stains to be treated. The kind of run-off familiar from thin liquid compositions is prevented as a result.

Polymers originating in nature which are used as thickeners are, for example, agar-agar, carrageen, tragacanth, gum arabic, alginates, pectins, polyoses, guar flour, carob seed flour, starch, dextrins, gelatins and casein.

Modified natural substances originate primarily from the group of modified starches and celluloses, examples which may be mentioned here being carboxymethylcellulose and cellulose ethers, hydroxyethyl-cellulose and hydroxypropylcellulose, and carob flour ether.

A large group of thickeners which is used widely in very diverse fields of application are the completely synthetic polymers, such as polyacrylic and polymethacrylic compounds, vinyl polymers, polycarboxylic acids, polyethers, polyimines, polyamides and polyurethanes.

Thickeners from said classes of substance are commercially widely available and are offered, for example, under the trade names Acusol®-820 (methacrylic acid (stearyl alcohol-20-EO) ester-acrylic acid copolymer, 30% strength in water, Rohm & Haas), Dapral®-GT-282-S (alkyl polyglycol ether, Akzo), Deuterol®-Polymer-11 (dicarboxylic acid copolymer, Schoner GmbH), Deuteron®-XG (anionic heteropolysaccharide based on β-D-glucose, D-manose, D-glucuronic acid, Schoner GmbH), Deuteron®-XN (nonionogenic polysaccharide, Schoner GmbH), Dicrylan®-Verdicker-O (ethylene oxide adduct, 50% strength in water/isopropanol, Pfersse Chemie), EMA®-81 and EMA®-91 (ethylene-maleic anhydride copolymer, Monsanto), Verdicker-QR-1001 (polyurethane emulsion, 19-21% strength in water/diglycol ether, Rohm & Haas), Mirox®-AM (anionic acrylic acid-acrylic ester copolymer dispersion, 25% strength in water, Stockhausen), SER-AD-FX-1100 (hydrophobic urethane polymer, Servo Delden), Shellflo®-S (high molecular weight polysaccharide, stabilized with formaldehyde, Shell), and Shellflo®-XA (xanthan biopolymer, stabilized with formaldehyde, Shell).

A preferred polymeric polysaccharide thickener is xanthan, a microbial anionic heteropolysaccharide produced by Xanthomonas campestris and other species under aerobic conditions and has a molar mass in the range from 2 to 15 million g/mol. Xanthan is formed from a chain of β-1,4-bound glucose (cellulose) having side chains. The structure of the subgroups consists of glucose, mannose, glucuronic acid, acetate and pyruvate, the number of pyruvate units determining the viscosity of the xanthan.

Because of their substantial stability to acid and oxidation it is particularly advantageous to use xanthans and modified xanthans.

Xanthan can be described by the following formula:

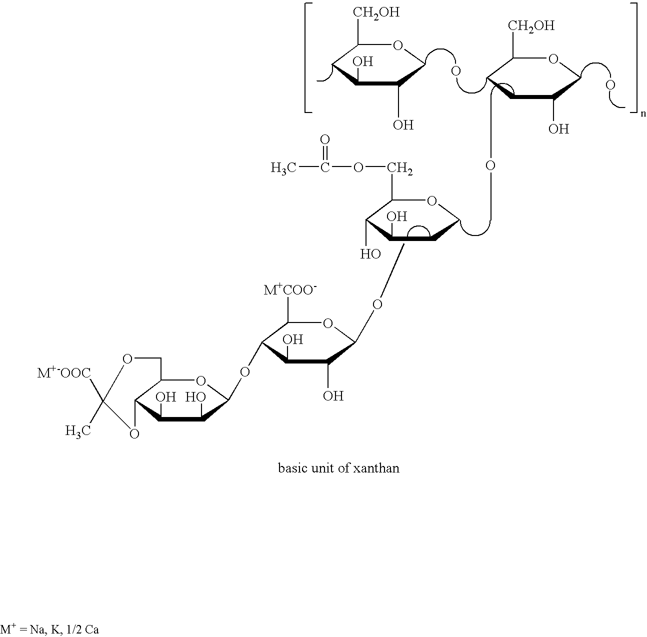

In a preferred embodiment the liquid laundry detergents of the present invention further comprise thickeners, preferably in amounts up to 10% by weight, more preferably up to 5% by weight and especially in the range from 0.1% to 1% by weight, each based on the entire composition.

Furthermore, the present invention's liquid textile-cleaning compositions or mild-action laundry detergent compositions or liquid laundry detergent compositions or nonaqueous liquid laundry detergent compositions may further comprise odor absorbers or dye transfer inhibitors. Especially the mild-action and liquid laundry detergent compositions of the present invention benefit from the use of dye transfer inhibitors. The use of odor absorbers will prove very helpful to deodorize malodorous formulating constituents, such as amine-containing components for example, but also for sustained deodorization of washed textiles.

In a preferred embodiment the compositions of the present invention comprise if appropriate from 0.1% by weight to 2% by weight and preferably from 0.2% by weight to 1% by weight of dye transfer inhibitor, which in a preferred embodiment of the invention is a polymer of vinylpyrrolidone, vinylimidazole, vinylpyridine N-oxide or a copolymer of these. Useful dye transfer inhibitors include not only the polyvinylpyrrolidones of molecular weights in the range from 15 000 to 50 000 which are known for example from European patent application EP 0 262 897 but also the polyvinylpyrrolidones having molar weights above 1 000 000, especially from 1 500 000 to 4 000 000, which are known from the international patent application WO 95/06098, the N-vinylimidazole-N-vinylpyrrolidone copolymers known from the German patent applications DE 28 14 287 or DE 38 03 630 or the international patent applications WO 94/10281, WO 94/26796, WO 95/03388 and WO 95/03382, the polyvinyloxazolidones known from German patent application DE 28 14 329, the copolymers based on vinyl monomers and carboxamides that are known from European patent application EP 610 846, the polyesters and polyamides containing pyrrolidone groups that are known from international patent application WO 95/09194, the grafted polyamidoamines and polyethyleneimines known from international patent application WO 94/29422, the polymers with amide groups from secondary amines that are known from German patent application DE 43 28 254, the polyamine N-oxide polymers known from international patent application WO 94/02579 or European patent application EP 0 135 217, the polyvinyl alcohols known from European patent application EP 0 584 738, and the copolymers based on acrylamidoalkenylsulfonic acids that are known from European patent application EP 0 584 709. However, it is also possible to use enzymatic systems, comprising a peroxidase and hydrogen peroxide or a substance which in water provides hydrogen peroxide, as are known, for example, from international patent applications WO 92/18687 and WO 91/05839. The addition of a mediator compound for the peroxidase, for example, an acetosyringone known from international patent application WO 96/10079, a phenol derivative known from international patent application WO 96/12845, or a phenothiazine or phenoxazine known from international patent application WO 96/12846, is preferred in this case, it being also possible to use abovementioned active polymeric dye transfer inhibitor substances as well. Polyvinyl-pyrrolidone for use in compositions of the invention preferably has an average molar mass in the range from 10 000 to 60 000, in particular in the range from 25 000 to 50 000. Among the copolymers, preference is given to those of vinylpyrrolidone and vinylimidazole in a molar ratio of 5:1 to 1:1 having an average molar mass in the range from 5000 to 50 000, in particular from 10 000 to 20 000.

Preferred deodorizing substances for the purposes of the present invention include one or more metal salts of a branched or unbranched, saturated or unsaturated, singly or multiply hydroxylated fatty acid having 16 or more carbon atoms and/or a resin acid except for the alkali metal salts and also any desired mixtures thereof.

Ricinoleic acid is a particularly preferred branched or unbranched, saturated or unsaturated, singly or multiply hydroxylated fatty acid having 16 or more carbon atoms. Abietic acid is a particularly preferred resin acid.

Preferred metals are the transition metals and the lanthanoids, especially the transition metals of groups VIIIa, Ib and IIb of the periodic table and also lanthanum, cerium and neodymium, more preferably cobalt, nickel, copper and zinc and extremely preferably zinc. The cobalt, nickel and copper salts and the zinc salts are similarly effective, however, zinc salts are preferable for toxicological reasons.

Deodorizing substances which are advantageous and therefore particularly preferable for use include one or more metal salts of ricinoleic acid and/or of abietic acid, preferably zinc ricinoleate and/or zinc abietate, especially zinc ricinoleate.

Useful deodorizing substances for the purposes of the present invention further include cyclodextrins and also any desired mixtures of the aforementioned metal salts with cyclodextrins, preferably in a weight ratio of 1:10 to 10:1, more preferably of 1:5 to 5:1 and especially of 1:3 to 3:1. The term “cyclodextrin” as used herein comprehends all known cyclodextrins, i.e., not only unsubstituted cyclodextrins having 6 to 12 glucose units, especially alpha-, beta- and gamma-cyclodextrins and their mixtures and/or their derivatives and/or their mixtures.

The present invention's liquid textile-cleaning compositions or mild-action laundry detergent compositions or liquid laundry detergent compositions or nonaqueous liquid laundry detergent compositions may further comprise further surfactants, for example amphoteric surfactants.

Useful amphosurfactants (zwitterionic surfactants) for the purposes of the present invention include betaines, amine oxides, alkylamidoalkylamines, alkyl-substituted amino acids, acylated amino acids and biosurfactants, particular preference being given for the purposes of the teaching according to the invention to the betaines.

Suitable betaines are the alkylbetaines, the alkylamidobetaines, the imidazoliniumbetaines, the sulfo-betaines (INCI Sultaines), and the phosphobetaines and preferably satisfy the formula I,
R¹—[CO—X—(CH₂)ₙ]ₓ—N⁺(R²)(R³)—(CH₂)ₘ—[CH(OH)—CH₂]_{y}—Y⁻ (I)
in which R¹ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,
X is NH, NR⁴ with the C₁₋₄-alkyl radical R⁴, O or S,
n is a number from 1 to 10, preferably 2 to 5, in particular 3,
x is 0 or 1, preferably 1,
R²,R³ independently of one another are a C₁₋₄-alkyl radical, optionally hydroxy-substituted, such as e.g. a hydroxyethyl radical, but in particular a methyl radical,
m is a number from 1 to 4, in particular 1, 2 or 3,
y is 0 or 1, and
Y is COO, SO₃, OPO(OR⁵)O or P(O) (OR⁵)O, where R⁵ is a hydrogen atom H or a C₁₋₄-alkyl radical.

The alkyl- and alkylamidobetaines, betaines of the formula I with a carboxylate group (Y⁻═COO⁻) are also called carbobetaines.

Preferred amphoteric surfactants are the alkylbetaines of the formula (Ia), the alkylamidobetaines of the formula (Ib), the sulfobetaines of the formula (Ic) and the amidosulfobetaines of the formula (Id),
R¹—N⁺(CH₃)₂—CH₂COO⁻ (Ia)
R¹—CO—NH—(CH₂)₃—N⁺(CH₃)₂—CH₂COO⁻ (Ib)
R¹—N⁺(CH₃)₂—CH₂CH(OH CH₂SO₃⁻ (Ic)
R¹—CO—NH—(CH₂)₃—N⁺(CH₃)₂—CH₂CH(OH)CH₂SO₃⁻ (Id)
in which R¹ has the same meaning as in formula I.

Particularly preferred amphoteric surfactants are the carbobetaines, in particular the carbobetaines of the formula (Ia) and (Ib), most preferably the alkylamido-betaines of the formula (Ib).

Examples of suitable betaines and sulfobetaines are the following compounds named according to INCI: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kernelamiodopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallow-amidopropyl Betaine, Tallowamidopropyl Hydroxysultaine, Tallow Betaine, Tallow Dihydroxyethyl Betaine, Undecylen-amidopropyl Betaine and Wheat Germamidopropyl Betaine.

Amine oxides suitable according to the invention include alkylamine oxides, in particular alkyldimethylamine oxides, alkylamidoamine oxides and alkoxyalkylamine oxides. Preferred amine oxides satisfy the formula II,
R⁶R⁷R⁸N⁺—O⁻ (II)
R⁶—[CO—NH—(CH₂)_{w}]_{z}—N⁺(R⁷)(R⁸)—O⁻ (II)
in which R⁶ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical, which is bonded to the nitrogen atom N in the alkylamidoamine oxides via a carbonylamidoalkylene group —CO—NH—(CH₂)_{z}, and in the alkoxyalkylamine oxides via an oxaalkylene group —O—(CH₂)_{z}, where z is in each case a number from 1 to 10, preferably 2 to 5, in particular 3,
R⁷,R⁸ independently of one another are a C₁₋₄-alkyl radical, optionally hydroxy-substituted, such as e.g. a hydroxyethyl radical, in particular a methyl radical.

Examples of suitable amine oxides are the following compounds named in accordance with INCI: Almond-amidopropylamine Oxide, Babassuamidopropylamine Oxide, Behenamine Oxide, Cocamidopropyl Amine Oxide, Cocamidopropylamine Oxide, Cocamine Oxide, Coco-Morpholine Oxide, Decylamine Oxide, Decyltetradecylamine Oxide, Diaminopyrimidine Oxide, Dihydroxyethyl C8-10 Alkoxypropylamine Oxide, Dihydroxyethyl C9-11 Alkoxypropylamine Oxide, Dihydroxyethyl C12-15 Alkoxypropylamine Oxide, Dihydroxyethyl Cocamine Oxide, Dihydroxyethyl Lauramine Oxide, Dihydroxyethyl Stearamine Oxide, Dihydroxyethyl Tallowamine Oxide, Hydrogenated Palm Kernel Amine Oxide, Hydrogenated Tallowamine Oxide, Hydroxyethyl Hydroxypropyl C12-15 Alkoxypropylamine Oxide, Isostearamidopropylamine Oxide, Isostearamidopropyl Morpholine Oxide, Lauramidopropylamine Oxide, Lauramine Oxide, Methyl Morpholine Oxide, Milkamidopropyl Amine Oxide, Minkamidopropylamine Oxide, Myristamidopropylamine Oxide, Myristamine Oxide, Myristyl/Cetyl Amine Oxide, Oleamidopropylamine Oxide, Oleamine Oxide, Olivamido-propylamine Oxide, Palmitamidopropylamine Oxide, Palmitamine Oxide, PEG-3 Lauramine Oxide, Potassium Dihydroxyethyl Cocamine Oxide Phosphate, Potassium Tris phosphonomethylamine Oxide, Sesamidopropylamine Oxide, Soyamidopropylamine Oxide, Stearamidopropylamine Oxide, Stearamine Oxide, Tallowamidopropylamine Oxide, Tallowamine Oxide, Undecylenamidopropylamine Oxide and Wheat Germamidopropylamine Oxide.

The alkylamidoalkylamines (INCI Alkylamido Alkylamines) are amphoteric surfactants of the formula (III)
R⁹—CO—NR¹⁰—(CH₂)ᵢ—N(R¹¹)—(CH₂CH₂O)ⱼ—(CH₂)ₖ—[CH(OH)]₁—CH₂-Z-OM (III)
in which R⁹ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,
R¹⁰ is a hydrogen atom H or a C₁₋₄-alkyl radical, preferably H,
i is a number from 1 to 10, preferably 2 to 5, in particular 2 or 3,
R¹¹ is a hydrogen atom H or CH₂COOM (for M see below),
j is a number from 1 to 4, preferably 1 or 2, in particular 1,
k is a number from 0 to 4, preferably 0 or 1,
l is 0 or 1, where k=1, if l=1,
Z is CO, SO₂, OPO(OR¹²) or P(O)(OR¹²), where R¹² is a C₁₋₄-alkyl radical or is M (see below) and
M is hydrogen, an alkali metal, an alkaline earth metal or a protonated alkanolamine, e.g. protonated mono-, di- or triethanolamine.

Preferred representatives satisfy the formulae IIIa to IIId,
R⁹—CO—NH—(CH₂)₂—N(R¹¹)—CH₂CH₂O—CH₂—COOM (IIIa)
R⁹—CO—NH—(CH₂)₂—N(R¹¹)—CH₂CH₂O—CH₂CH₂—COOM (IIIb)
R⁹—CO—NH—(CH₂)₂—N(R¹¹)—CH₂CH₂O—CH₂CH(OH)CH₂—SO₃M (IIIc)
R⁹—CO—NH—(CH₂)₂—N(R¹¹)—CH₂CH₂O—CH₂CH(OH)CH₂—OPO₃HM (IIId)
in which R¹¹ and M have the same meanings as in formula (III).

Examples of alkylamidoalkylamines are the following compounds named in accordance with INCI: Cocoamphodipropionic Acid, Cocobetainamido Amphopropionate, DEA-Cocoamphodipropionate, Disodium Caproamphodiacetate, Disodium Caproamphodipropionate, Disodium Capryloamphodiacetate, Disodium Capryloamphodipropionate, Disodium Cocoamphocarboxyethylhydroxypropylsulfonate, Disodium Cocoamphodiacetate, Disodium Cocoamphodipropionate, Disodium Isostearoamphodiacetate, Disodium Isostearoamphodipropionate, Disodium Laureth-5 Carboxyamphodiacetate, Disodium Lauroamphodiacetate, Disodium Lauroamphodipropionate, Disodium Oleoamphodipropionate, Disodium PPG-2-Isodeceth-7 Carboxyamphodiacetate, Disodium Stearoamphodiacetate, Disodium Tallowamphodiacetate, Disodium Wheatgermamphodiacetate, Lauroamphodipropionic Acid, Quaternium-85, Sodium Caproamphoacetate, Sodium Caproamphohydroxypropylsulfonate, Sodium Caproamphopropionate, Sodium Capryloamphoacetate, Sodium Capryloamphohydroxypropylsulfonate, Sodium Capryloamphopropionate, Sodium Cocoamphoacetate, Sodium Cocoamphohydroxypropylsulfonate, Sodium Cocoamphopropionate, Sodium Cornamphopropionate, Sodium Isostearoamphoacetate, Sodium Isostearoamphopropionate, Sodium Lauroamphoacetate, Sodium Lauroamphohydroxypropylsulfonate, Sodium Lauroampho PG-Acetate Phosphate, Sodium Lauroamphopropionate, Sodium Myristoamphoacetate, Sodium Oleoamphoacetate, Sodium Oleoamphohydroxypropylsulfonate, Sodium Oleoamphopropionate, Sodium Ricinoleoamphoacetate, Sodium Stearoamphoacetate, Sodium Stearoamphohydroxypropylsulfonate, Sodium Stearoamphopropionate, Sodium Tallamphopropionate, Sodium Tallowamphoacetate, Sodium Undecylenoamphoacetate, Sodium Undecylenoamphopropionate, Sodium Wheat Germamphoacetate and Trisodium Lauroampho PG-Acetate Chloride Phosphate.

Alkyl-substituted amino acids (INCI Alkyl-Substituted Amino Acids) preferred according to the invention are monoalkyl-substituted amino acids according to formula (IV)
R¹³—NH—CH(R¹⁴)—(CH₂)ᵤ—COOM′ (IV)
in which R¹³ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,
R¹⁴ is a hydrogen atom H or a C₁₋₄-alkyl radical, preferably H,
u is a number from 0 to 4, preferably 0 or 1, in particular 1, and
M′ is hydrogen, an alkali metal, an alkaline earth metal or a protonated alkanolamine, e.g. protonated mono-, di- or triethanolamine,
   alkyl-substituted imino acids according to the formula (V)
   R¹⁵—N—[(CH₂)ᵥ—COOM″]₂ (V)
   in which R¹⁵ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,
v is a number from 1 to 5, preferably 2 or 3, in particular 2, and
M″ is hydrogen, an alkali metal, an alkaline earth metal or a protonated alkanolamine, e.g. protonated mono-, di- or triethanolamine, where M″ in the two carboxyl groups can have the same meaning or two different meanings, e.g. hydrogen and sodium or sodium and sodium,
   and mono- and dialkyl-substituted natural amino acids according to formula (VI)
   R¹⁶—N(R¹⁷)—CH(R¹⁸)—COOM′″ (VI)
   in which R¹⁶ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,
R¹⁷ is a hydrogen atom or a C₁₋₄-alkyl radical, optionally hydroxy- or amino-substituted, e.g. a methyl, ethyl, hydroxyethyl or aminopropyl radical,
R¹⁸ is the radical of one of the 20 natural α-amino acids H₂NCH(R¹⁸)COOH, and
M′″ is hydrogen, an alkali metal, an alkaline earth metal or a protonated alkanolamine, e.g. protonated mono-, di- or triethanolamine.

Particularly preferred alkyl-substituted amino acids are the aminopropionates according to formula (IVa)
R¹³—NH—CH₂CH₂COOM′ (IVa)
in which R¹³ and M′ have the same meanings as in formula (IV).

Examples of alkyl-substituted amino acids are the following compounds named in accordance with INCI: Aminopropyl Laurylglutamine, Cocaminobutyric Acid, Cocaminopropionic Acid, DEA-Lauraminopropionate, Disodium Cocaminopropyl Iminodiacetate, Disodium Dicarboxyethyl Cocopropylenediamine, Disodium Lauriminodipropionate, Disodium Steariminodipropionate, Disodium Tallowiminodipropionate, Lauraminopropionic Acid, Lauryl Aminopropylglycine, Lauryl Diethylenediaminoglycine, Myristaminopropionic Acid, Sodium C12-15 Alkoxypropyl Iminodipropionate, Sodium Cocaminopropionate, Sodium Lauraminopropionate, Sodium Lauriminodipropionate, Sodium Lauroyl Methylaminopropionate, TEA-Lauraminopropionate and TEA-Myristaminopropionate.

Acylated amino acids are amino acids, in particular the 20 natural α-amino acids which carry the acyl radical R¹⁹CO of a saturated or unsaturated fatty acid R¹⁹COOH on the amino nitrogen atom, where R¹⁹ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical. The acylated amino acids can also be used as alkali metal salt, alkaline earth metal salt or alkanolammonium salt, e.g. mono-, di- or triethanolammonium salt. Examples of acylated amino acids are the acyl derivatives grouped together according to INCI under Amino Acids, e.g. Sodium Cocoyl Glutamate, Lauroyl Glutamic Acid, Capryloyl Glycine or Myristoyl Methylalanine.

In a preferred embodiment the total surfactant content without the amount of fatty acid soap is below 55% by weight, preferably below 50% by weight, more preferably between 38% and 48% by weight, each based on the entire composition.

The present invention's liquid textile-cleaning compositions or mild-action laundry detergent compositions or liquid laundry detergent compositions or nonaqueous liquid laundry detergent compositions may further comprise further laundry detergent additives, for example from the group of builders, bleaches, bleach activators, electrolytes, pH standardizers, scents, perfume-carriers, fluorescent agents, dyes, foam inhibitors, grayness inhibitors, crease control agents, antimicrobial actives, germicides, fungicides, antioxidants, antistats, ironing aids, UV absorbers, optical brighteners, antiredeposition agents, viscosity regulators, shrinkage preventatives, corrosion inhibitors, preservatives, phobicizers and impregnants.

The compositions of the present invention may comprise builders.

Any builder customarily used in washing and cleaning compositions can be incorporated in the compositions of the present invention, including especially zeolites, silicates, carbonates, organic cobuilders and even—where there are no ecological prejudices against their use—phosphates.

Useful crystalline, sheet-shaped sodium silicates have the general formula NaMSiₓO₂ₓ₊₁.H₂O, where M is sodium or hydrogen, x is from 1.9 to 4, y is from 0 to 20 and x is preferably 2, 3 or 4. Such crystalline sheet silicates are described for example in European patent application EP-A-0 164 514. Preferred crystalline sheet silicates of the stated formula are those in which M is sodium and x is 2 or 3. In particular, not only β- but also δ-sodium disilicates Na₂Si₂O₅.yH₂O are preferred, β-sodium disilicate being obtainable for example by the process described in international patent application WO-A-91/08171.

It is also possible to use amorphous sodium silicates having an Na₂O:SiO₂ modulus of from 1:2 to 1:3.3, preferably from 1:2 to 1:2.8 and in particular from 1:2 to 1:2.6, which are dissolution-delayed and have secondary washing properties. The dissolution delay relative to conventional amorphous sodium silicates may have been brought about in a variety of ways, for example by surface treatment, compounding, compacting or by overdrying. For the purposes of this invention the term “amorphous” is understood as including “X-ray-amorphous”. This means that, in X-ray diffraction experiments, the silicates do not yield the sharp X-ray reflections typical of crystalline substances but instead yield at best one or more maxima of the scattered X-radiation, having a width of several degree units of the diffraction angle. However, even particularly good builder properties may result if the silicate particles in electron diffraction experiments yield vague or even sharp diffraction maxima. This is to be interpreted such that the products have micro-crystalline regions with a size of from 10 to several hundred nm, values up to a maximum of 50 nm and in particular up to a maximum of 20 nm being preferred. Such so-called X-ray amorphous silicates likewise have delayed dissolution compared with conventional waterglasses and are described in German patent application DE-A-44 00 024. Particular preference is given to compacted amorphous silicates, compounded amorphous silicates and overdried X-ray amorphous silicates.

The finely crystalline synthetic zeolite used, containing bound water, is preferably zeolite A and/or P. Zeolite P is particularly preferably Zeolite MAP® (commercial product from Crosfield). Also suitable, however, are zeolite X, and mixtures of A, X and/or P. A co-crystallizate of zeolite X and zeolite A (about 80% by weight of zeolite X), which is sold by CONDEA Augusta S.p.A. under the trade name VEGOBOND AX® and can be described by the formula
nNa₂O.(1-n)K₂O.Al₂O₃.(2-2.5)SiO₂.(3.5-5.5)H₂O
is, for example, also commercially available and preferred for the purposes of the present invention. Useful zeolites have an average particle size of less than 10 μm (volume distribution; method of measurement: Coulter Counter) and have a bound-water content which is preferably in the range from 18% to 22% by weight and especially in the range from 20% to 22% by weight. The zeolites can also be used as over-dried zeolites having lower water contents and then are by virtue of their hygroscopicity useful to remove unwanted trace residues of free water.

It will be appreciated that the well-known phosphates can likewise be used as builder substances, unless such a use is to be avoided for ecological reasons. Useful phosphates include in particular the sodium salts of the orthophosphates, of the pyrophosphates and especially of the tripolyphosphates.

Organic builder substances useful as cobuilders and obviously also as viscosity regulators include for example the polycarboxylic acids which can be used in the form of their sodium salts, polycarboxylic acids referring to carboxylic acids having more than one acid function. Examples thereof are citric acid, adipic acid, succinic acid, glutaric acid, malic acid, tartaric acid, maleic acid, fumaric acid, sugar acids, amino carboxylic acids, nitrilotriacetic acid (NTA) and derivatives thereof and also mixtures of these. Preferred salts are the salts of polycarboxylic acids such as citric acid, adipic acid, succinic acid, glutaric acid, tartaric acid, sugar acids and mixtures of these.

The acids themselves can be used as well. As well as their builder action, the acids typically also have the property of an acidifying component and thus also serve to impart a lower and milder pH to washing or cleaning compositions. Particularly used for this are citric acid, succinic acid, glutaric acid, adipic acid, gluconic acid and any desired mixtures of these. Useful acidifying agents further include known pH regulators such as sodium bicarbonate and sodium hydrogensulfate.

Useful builders further include polymeric polycarboxylates, i.e., for example the alkali metal salts of polyacrylic acid or of polymethacrylic acid, for example those having a relative molecular mass in the range from 500 to 70 000 g/mol.

The molar masses reported herein for polymeric polycarboxylates are weight average molar masses M_{w} of the respective acid form, determined in principle by means of gel permeation chromatography (GPC) using a UV detector. The measurement was made against an external polyacrylic acid standard which, owing to its structural similarity to the polymers under investigation, provides realistic molecular weight values. These figures differ considerably from the molecular weight values obtained using polystyrenesulfonic acids as a standard. The molar masses measured against polystyrenesulfonic acids are generally distinctly higher than the molar masses reported herein.

Useful polymers are in particular polyacrylates which preferably have a molecular mass in the range from 2000 to 20 000 g/mol. Owing to their superior solubility, preference in this group may be given in turn to the short-chain polyacrylates which have molar masses in the range from 2000 to 10 000 g/mol and more preferably in the range from 3000 to 5000 g/mol. Useful polymers may further include substances which partly or wholly consist of units of vinyl alcohol or its derivatives.

Useful polymeric polycarboxylates further include copolymeric polycarboxylates, especially those of acrylic acid with methacrylic acid and of acrylic acid or methacrylic acid with maleic acid. Of particular usefulness are copolymers of acrylic acid with maleic acid which comprise from 50% to 90% by weight of acrylic acid and from 50% to 10% by weight of maleic acid. Their relative molecular mass based on free acids is generally in the range from 2000 to 70 000 g/mol, preferably in the range from 20 000 to 50 000 g/mol and especially in the range from 30 000 to 40 000 g/mol. (Co)polymeric polycarboxylates can be used either as an aqueuous solution or preferably as a powder.

To improve solubility in water, polymers may further comprise allylsulfonic acids, such as allyloxybenzenesulfonic acid and methallylsulfonic acid in EP-B-0 727 448 for example, as a monomer.

Preference is also given in particular to biodegradable polymers composed of more than two different monomer units, for example those which as described in DE-A-43 00 772 comprise salts of acrylic acid and of maleic acid and also vinyl alcohol or vinyl alcohol derivatives as monomers or as described in DE-C-42 21 381 comprise salts of acrylic acid and of 2-alkylallylsulfonic acid and also sugar derivatives as monomers.

Preferred copolymers further include those described in the German patent applications DE-A-43 03 320 and DE-A-44 17 734 and which as monomers preferably comprise acrolein and acrylic acid/acrylic acid salts or acrolein and vinyl acetate.

Preferred builder substances further include polymeric amino dicarboxylic acids, their salts or their precursor substances. Particular preference is given to polyaspartic acids or salts and derivatives thereof, of which it is disclosed in German patent application DE-A-195 40 086 that they have a bleach-stabilizing effect as well as cobuilder properties. It is further possible to use polyvinylpyrrolidones, polyamine derivatives such as quaternized and/or ethoxylated hexamethylenediamines.

Useful builder substances further include polyacetals which can be obtained by reacting dialdehydes with polycarboxylic acids having 5 to 7 carbon atoms and 3 or more hydroxyl groups, as described for example in European patent application EP-A-0 280 223. Preferred polyacetals are obtained from dialdehydes such as glyoxal, glutaraldehyde, terephthalaldehyde and mixtures thereof and from polycarboxylic acids such as gluconic acid and/or glucoheptonic acid.

Useful organic builder substances further include dextrins, for example oligomers or polymers of carbohydrates obtainable by partial hydrolysis of starches. The hydrolysis can be carried out by customary, for example acid- or enzyme-catalyzed, processes. The hydrolysis products preferably have average molar masses in the range from 400 to 500 000 g/mol. Preference here is given to a polysaccharide having a dextrose equivalent (DE) in the range from 0.5 to 40 and especially from 2 to 30, DE being a common measure of the reducing effect of a polysaccharide compared with dextrose, which has a DE of 100. It is also possible to use maltodextrins having a DE between 3 and 10 and dried glucose syrups having a DE between 20 and 37, and also so-called yellow dextrins and white dextrins having relatively higher molar masses in the range from 2000 to 30 000 g/mol. A preferred dextrin is described in British patent application 94 19 091.

The oxidized derivatives of such dextrins are their reaction products with oxidizing agents which are able to oxidize at least one alcohol function of the saccharide ring to the carboxylic acid function. Such oxidized dextrins and processes for their preparation are known for example from European patent applications EP-A-0 232 202, EP-A-0 427 349, EP-A-0 472 042 and EP-A-0 542 496 and also international patent applications WO-A-92/18542, WO-A-93/08251, WO-A-93/16110, WO-A-94/28030, WO-A-95/07303, WO-A-95/12619 and WO-A-95/20608. It is likewise possible to use an oxidized oligosaccharide as described in German patent application DE-A-196 00 018. A product oxidized on the C₆ of the saccharide ring may be particularly advantageous.

Useful cobuilders further include oxydisuccinates and other derivatives of disuccinates, preferably ethylenediaminedisuccinate. Here, ethylenediamine-N,N′-disuccinate (EDDS), the synthesis of which is described in U.S. Pat. No. 3,158,615 for example, is preferably used in the form of its sodium or magnesium salts. Also preferable in this connection are glycerol disuccinates and glycerol trisuccinates as described for example in U.S. Pat. No. 4,524,009, U.S. Pat. No. 4,639,325, European patent application EP-A-0 150 930 and Japanese patent application JP-A-93/339 896. Suitable use levels in zeolite-containing and/or silicate-containing formulations range from 3% to 15% by weight.

Useful organic cobuilders further include for example acetylated hydroxycarboxylic acids and salts thereof, which may if desired also be present in lactone form and which comprise at least 4 carbon atoms and at least one hydroxyl group and also not more than two acid groups. Such cobuilders are described for example in international patent application WO 95/20029.

The compositions of the present invention may, if appropriate, comprise builders in amounts of from 1% to 30% by weight and preferably from 10% to 25% by weight. The nonaqueous liquid laundry detergent compositions of the present invention advantageously comprise as builders water-soluble builders, preferably from the group of oligo- and polycarboxylates, carbonates and crystalline or amorphous silicates. Of these compounds, the salts of citric acid will be particularly useful, the alkali metal salts, in particular the sodium salts, being preferred.

The compositions of the present invention, especially the nonaqueous liquid laundry detergent compositions of the present invention, may comprise bleaches.

Among compounds which serve as bleaches in that they liberate H₂O₂ in water, sodium percarbonate, sodium perborate tetrahydrate and sodium perborate monohydrate are of particular importance. Useful bleaches further include for example peroxypyrophosphates, citrate perhydrates and also H₂O₂-supplying peracidic salts or peracids, such persulfates and persulfuric acid. It is also possible to use urea peroxohydrate, i.e., percarbamide, which is described by the formula H₂N—CO—NH₂.H₂O₂. Especially when the compositions are used for cleaning hard surfaces, for example in dishwashers, they can if desired also include bleaches from the group of organic bleaches, although their use is in principle also possible in textile-washing compositions. Typical organic bleaches include diacyl peroxides, for example dibenzoyl peroxide. Typical organic bleaches further include peroxyacids, examples being in particular alkylperoxyacids and arylperoxyacids. Preferred representatives are peroxybenzoic acid and its ring-substituted derivatives, such as alkylperoxybenzoic acids, but also peroxy-α-naphthoic acid and magnesium monoperphthalate, aliphatic or substitutedly aliphatic peroxyacids, such as peroxylauric acid, peroxystearic acid, ε-phthalimidoperoxycaproic acid (phthalimidoperoxyhexanoic acid, PAP), o-carboxy-benzamidoperoxycaproic acid, N-nonenylamidoperadipic acid and N-nonenylamidopersuccinates, and alipahtic and araliphatic peroxydicarboxylic acids, such as 1,12-di-peroxy carboxylic acid, 1,9-diperoxyazelaic acid, diperoxysebacic acid, diperoxybrassylic acid, diperoxy-phthalic acids, 2-decyldiperoxybutane-1,4-diacid, N,N-terephthaloyldi(6-aminopercaproic acid). More preferably, the compositions of the present invention may comprise phthalimidoperoxyhexanoic acid (PAP). Bleaches may be coated to prevent premature decomposition.

The compositions of the present invention may comprise bleach activators.

Compounds used as bleach activators produce aliphatic peroxo carboxylic acids having preferably 1 to 10 carbon atoms and especially 2 to 4 carbon atoms and/or as the case may be substituted perbenzoic acid under perhydrolysis conditions. Substances which bear O- and/or N-acyl groups of the stated number of carbon atoms and/or substituted or unsubstituted benzoyl groups are suitable. Preference is given to multiply acylated alkylenediamines, especially tetraacetylethylenediamine (TAED), acylated triazine derivatives, especially 1,5-diacetyl-2,4-dioxohexahydro-1,3,5-triazine (DADHT), acylated glycolurils, especially tetraacetylglycoluril (TAGU), N-acylimides, especially N-nonanoylsuccinimide (NOSI), acylated phenolsulfonates, especially n-nonanoyl- or isononanoyloxybenzenesulfonate (n- and iso-NOBS respectively), carboxylic anhydrides, especially phthalic anhydride, acylated polyhydric alcohols, especially triacetin, triethyl acetylcitrate (TEAC), ethylene glycol diacetate, 2,5-diacetoxy-2,5-dihydrofuran and the enol esters known from German patent applications DE 196 16 693 and DE 196 16 767 and also acetylated sorbitol and mannitol or to be more precise their SORMAN mixtures described in European patent application EP 0 525 239, acylated sugar derivatives, especially pentaacetylglucose (PAG), pentaacetylfructose, tetraacetylxylose and octaacetyllactose and also acylated, optionally N-alkylated glucamine and gluconolactone, and/or N-acylated lactams, for example N-benzoylcaprolactam, which are each known from international patent applications WO 94/27970, WO 94/28102, WO 94/28103, WO 95/00626, WO 95/14759 and WO 95/17498. The hydrophilically substituted aceylacetals known from the German patent application DE 196 16 769 and the acyllactams described in the German patent application DE 196 16 770 and also the international patent application WO 95/14075 are likewise preferred. Similarly, the combinations of conventional bleach activators described in the German patent application DE 44 43 177 can likewise be used. A further class of preferred liquid bleach activators is that of the liquid imide bleach activators of the hereinbelow stated formula.

The compositions of the present invention may comprise electrolytes.

A large number of various salts can be used as electrolytes from the group of the inorganic salts. Preferred cations are the alkali and alkaline earth metals and preferred anions are the halides and sulfates. From the point of view of manufacturing convenience, the use of NaCl or MgCl₂ in the compositions of the present invention is preferred. The fraction of electrolytes in the compositions of the present invention is typically in the range from 0.5% to 5% by weight.

The compositions of the present invention may comprise pH standardizers.

To adjust the pH of the compositions according to the invention into the desired range, the use of pH standardizers may be indicated. Useful pH standardizers include all known acids and alkalis unless their use is ruled out by performance or ecological concerns or by consumer protection concerns. Typically, the amount of these standardizers does not exceed 2% by weight of the total formulation.

The compositions of the present invention may comprise dyes and fragrances.

Dyes and fragrances are added to the compositions of the invention in order to enhance the esthetic appeal of the products and to provide the consumer with not only the washing or cleaning performance but also a visually and sensorially “typical and unmistakable” product. As perfume oils and/or fragrances it is possible to use individual odorant compounds, examples being the synthetic products of the ester, ether, aldehyde, ketone, alcohol and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate and benzyl salicylate. The ethers include, for example, benzyl ethyl ether; the aldehydes include, for example, the linear alkanals having 8-18 carbon atoms, citral, citronellal, citronellyloxyacetaldehyde, cyclamenaldehyde, hydroxycitronellal, lilial and bourgeonal; the ketones include, for example, the ionones, α-isomethylionone and methyl cedryl ketone; the alcohols include anethol, citronellol, eugenol, geraniol, linalool, phenylethyl alcohol and terpineol; the hydrocarbons include primarily the terpenes such as limonene and pinene. Preference, however, is given to using mixtures of different odorants, which together produce an appealing fragrance note. Such perfume oils may also contain natural odorant mixtures, as are obtainable from plant sources, examples being pine oil, citrus oil, jasmine oil, patchouli oil, rose oil or ylang-ylang oil. Likewise suitable are muscatel, sage oil, camomile oil, clove oil, balm oil, mint oil, cinnamon leaf oil, lime blossom oil, juniper oil, vetiver oil, olibanum oil, galbanum oil and labdanumol oil, and also orange blossom oil, neroliol, orange peel oil and sandalwood oil.

The compositions of the present invention may comprise UV absorbers.

The compositions may comprise UV absorbers which go onto the treated textiles and improve the light stability of the fibers and/or the light stability of the other formula components. UV absorbers should be understood to mean organic substances (light filters) which are capable of absorbing ultraviolet rays and reemitting the absorbed energy in the form of longer-wave radiation, e.g. heat. Examples of compounds which have these desired properties are the compounds active through non-radiative deactivation and derivatives of benzophenone with substituents in the 2- and/or 4-position. Further, substituted benzotriazoles, such as for example the water-soluble benzenesulfonic acid-3-(2H-benzotriazol-2-yl)-4-hydroxy-5-(methylpropyl)-monosodium salt (Cibafast® H), acrylates phenyl-substituted in the 3-position (cinnamic acid derivatives), optionally with cyano groups in the 2-position, salicylates, organic Ni complexes and natural substances such as umbelliferone and the endogenous urocanic acid are suitable. Of particular importance are biphenyl derivatives and, above all, stilbene derivatives such as are for example described in EP 0728749 A and are commercially available from Ciba as Tinosorb® FD or Tinosorb® FR. As UV-B absorbers, mention can be made of 3-benzylidenecamphor and 3-benzylidene-norcamphor and derivatives thereof, e.g. 3-(4-methylbenzylidene)camphor, as described in EP 0693471 B1, 4-aminobenzoic acid derivatives, preferably 4-(dimethylamino)benzoic acid 2-ethylhexyl ester, 4-(dimethylamino)benzoic acid 2-octyl ester and 4-(dimethylamino)benzoic acid amyl ester, esters of cinnamic acid, preferably 4-methoxycinnamic acid 2-ethylhexyl ester, 4-methoxycinnamic acid propyl ester, 4-methoxycinnamic acid isoamyl ester and 2-cyano-3,3-phenylcinnamic acid 2-ethylhexyl ester (Octocrylene), esters of salicylic acid, preferably salicylic acid 2-ethylhexyl ester, salicylic acid 4-isopropylbenzyl ester and salicylic acid homomenthyl ester, derivatives of benzophenone, preferably 2-hydroxy-4-methoxybenzophenone, 2-hydroxy-4-methoxy-4′-methylbenzophenone and 2,2′-dihydroxy-4-methoxy-benzophenone, esters of benzalmalonic acid, preferably 4-methoxybenzmalonic acid di-2-ethylhexyl ester, triazine derivatives such as for example 2,4,6-trianilino-(p-carbo-2′-ethyl-1′-hexyloxy)-1,3,5-triazine and octyl triazone, as described in EP 0818450 A1 or dioctyl butamido triazone (Uvasorb® HEB), propane-1,3-diones such as for example 1-(4-tert-butylphenyl)-3-(4′-methoxyphenyl)propane-1,3-dione and ketotricyclo-(5.2.1.0)decane derivatives, as described in EP 0694521 B1. Also suitable are 2-phenylbenzimidazole-5-sulfonic acid and alkali metal, alkaline earth metal, ammonium, alkylammonium, alkanolammonium and glucammonium salts thereof, sulfonic acid derivatives of benzophenones, preferably 2-hydroxy-4-methoxybenzophenone-5-sulfonic acid and salts thereof, sulfonic acid derivatives of 3-benzylidenecamphor, such as for example 4-(2-oxo-3-bornylidenemethyl)benzene-sulfonic acid and 2-methyl-5-(2-oxo-3-bornylidene)sulfonic acid and salts thereof. Typical UV-A filters are in particular derivatives of benzoylmethane, such as for example 1-(4′-tert-butyl-phenyl)-3-(4′-methoxyphenyl)propane-1,3-dione, 4-tert-butyl-4′-methoxydibenzoylmethane (Parsol 1789), 1-phenyl-3-(4′-isopropylphenyl)-propane-1,3-dione and also enamine compounds, as described in DE 19712033 A1 (BASF). The UV-A and UV-B filters can of course also be used as mixtures. In addition to the stated soluble substances, insoluble light-protective pigments, that is finely dispersed preferably nanoized metal oxides or salts, are also possible for this. Examples of suitable metal oxides are in particular zinc oxide and titanium dioxide and also oxides of iron, zirconium, silicon, manganese, aluminum and cerium and also mixtures thereof. As salts, silicates (talc), barium sulfate or zinc stearate can be used. The oxides and salts are already used in the form of the pigments for skincare and skin protection emulsions and decorative cosmetics. The particles here should have a mean diameter of less than 100 nm, preferably between 5 and 50 nm and in particular between 15 and 30 nm. They can be spherical in shape, but particles having an ellipsoidal shape or a shape deviating in other ways from the spherical form can also be used. The pigments can also be surface-treated, i.e. hydrophobized or hydrophilized. Typical examples are coated titanium dioxides, such as for example titanium dioxide T 805 (Degussa) or Eusolex® T2000 (Merck). Possible hydrophobic coating agents here are above all silicones and specifically trialkoxyoctyl-silanes or simethicones. Preferably, micronized zinc oxide is used. Further suitable UV filters can be found in the review by P. Finkel in SÖFW Journal 122, 543 (1996).

UV absorbers are typically used in amounts ranging from 0.01% by weight to 5% by weight and preferably from 0.03% by weight to 1% by weight.

The compositions of the present invention may comprise crease control agents.

Since textile fabrics, especially those composed of rayon, wool, cotton and blends thereof, can tend to crease because the individual fibers are sensitive to bending, kinking, pressing and squashing transversely to the fiber direction, the compositions may comprise synthetic anticrease agents. These include for example synthetic products based on fatty acids, fatty acid esters, fatty acid amides, fatty acid alkylolesters, fatty acid alkylolamides or fatty alcohols, which have mostly been reacted with ethylene oxide, or products based on lecithin or modified phosphoric esters.

The compositions of the present invention may comprise grayness inhibitors.

Grayness inhibitors are designed to keep the soil detached from the fiber suspended in the liquor and to prevent its redeposition on the fiber. Useful grayness inhibitors include water-soluble colloids mostly organic in nature, for example glue, gelatin, salts of ether sulfonic acids of starch or of cellulose or salts of acidic sulfuric esters of cellulose or of starch. Similarly, water-soluble polyamides which comprise acidic groups are suitable for this purpose. It is also possible to use soluble starch preparations and starch products other than those mentioned above, for example degraded starch, aldehyde starches, etc. Polyvinylpyrrolidone can be used as well. However, preference is given to cellulose ethers such as carboxymethylcellulose (sodium salt), methylcellulose, hydroxyalkylcellulose and mixed ethers such as methylhydroxyethylcellulose, methylhydroxypropylcellulose, methyl-carboxymethylcellulose.

In a particularly preferred embodiment the nonaqueous liquid detergent compositions of the present invention are present as a portion in a wholly or partly water-soluble envelope. Nonaqueous portions of liquid laundry detergent facilitate metering for the consumer.

The nonaqueous liquid detergent compositions may be present packed in film pouches for example. Film pouches composed of water-soluble film make it unnecessary for the consumer to tear open the pack. This permits simple dosing of an individual portion for a wash cycle by placing the pouch directly into the washing machine or by chucking the pouch into a certain amount of water, for example in a bucket, bowl or basin or sink. The film bag which surrounds the detergent portion dissolves without residue on attainment of a certain temperature. Laundry detergent compositions packaged in pouches made of water-soluble film have likewise been described in large numbers in the prior art. For instance, prior patent application DE 198 31 703 discloses a portioned washing or cleaning composition in a bag of water-soluble film, especially in a bag of (optionally acetalated) polyvinyl alcohol (PVAL) wherein not less than 70% by weight of the particles of the washing or cleaning composition are >800 μm in size.

Numerous processes for producing water-soluble portions of laundry detergent composition already exist in the prior art and are hereby incorporated herein. The best known process is the tubular film process involving horizontal and vertical sealing seams. Film pouches or dimensionally stable portions of laundry detergent composition can also be produced by the thermoforming process as described for example in WO-A1 00/55068.

The water-soluble envelopes need not necessarily consist of a film material, but can also constitute dimensionally stable receptacles, which are obtainable by an injection-molding process for example.

A known process for producing water-soluble injection moldings comprising washing and/or cleaning composition is described for example in WO-A1 01/36290.

The prior art further discloses processes for producing water-soluble capsules composed of polyvinyl alcohol or gelatin which in principle make it possible to provide capsules having a high fill level. The processes involve the water-soluble polymer being introduced into a shaping cavity. Filling and sealing of the capsules takes place either concurrently or in successive steps, the filling taking place through a small opening in the latter case. Processes wherein filling and sealing take place concurrently are described for example in WO 97/35537. The capsules are filled through a filling wedge which is disposed above two counterrotating drums comprising semispherical shells on their surface. The drums guide polymeric bands which cover the semispherical-shell cavities. At the positions where the polymeric band of one drum coincides with the polymeric band of the opposite drum, sealing takes place. At the same time, the charge is injected into the capsule being formed, the pressure of injection of the liquid charge pressing the polymeric bands into the semispherical-shell cavities.

A process for producing water-soluble capsules where filling is a first step and sealing a second step is disclosed in WO 01/64421. The production operation is based on the Bottle-Pack® process as described for example in German Offenlegungsschrift DE 14 114 69. It involves a tubular preform being led into a two-part cavity. The cavity is closed to seal the lower tube section and subsequently the tube is expanded to fill out the capsule situated in the cavity, filled and subsequently sealed.

The envelope material used for producing the water-soluble portion is preferably a water-soluble polymeric thermoplastic, more preferably selected from the group consisting of (optionally partially acetalated) polyvinyl alcohol, polyvinyl alcohol copolymers, polyvinylpyrrolidone, polyethylene oxide, gelatin, cellulose and its derivatives, starch and its derivatives, blends and composites, inorganic salts and mixtures thereof, preferably hydroxypropylmethylcellulose and/or polyvinyl alcohol blends.

The above-described polyvinyl alcohols are commercially available, for example under the trade mark Mowiol® (Clariant). Polyvinyl alcohols which are particularly useful in the present invention are for example Mowiol® 3-83, Mowiol® 4-88, Mowiol® 5-88, Mowiol® 8-88 and also Clariant L648.

Polyvinyl alcohols particularly useful for the hollow bodies further include those in the following table:

| | Degree of | Molar | Melting |
|---|---|---|---|
| Designation | hydrolysis [%] | mass [kDa] | point [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23 600 | 100 |
| Gohsefimer ® LL02 | 41-51 | 17 700 | 100 |

Polyvinyl alcohols useful for the envelope further include ELVANOL® 51-05, 52-22, 50-42, 85-82, 75-15, T-25, T-66, 90-50 (Du Pont trade mark), ALCOTEX® 72.5, 78, B72, F80/40, F88/4, F88/26, F88/40, F88/47 (Harlow Chemical Co. trade mark), Gohsenol® NK-05, A-300, AH-22, C-500, GH-20, GL-03, GM-14L, KA-20, KA-500, KH-20, KP-06, N-300, NH-26, NM11Q, KZ-06 (Nippon Gohsei K.K. trade mark).

The water-soluble thermoplastic used for producing the portion according to the present invention may further comprise polymers selected from the group comprising acrylic acid-containing polymers, polyacrylamides, oxazoline polymers, polystyrenesulfonates, polyurethanes, polyesters, polyethers and/or mixtures thereof.

It is preferable when the water-soluble thermoplastic used comprises a polyvinyl alcohol whose degree of hydrolysis is in the range from 70 to 100 mol %, preferably from 80 to 90 mol %, more preferably from 81 to 89 mol % and especially from 82 to 88 mol %.

It is further preferable when the water-soluble thermoplastic used comprises a polyvinyl alcohol whose molecular weight is in the range from 10 000 to 100 000 gmol⁻¹, preferably from 11 000 to 90 000 gmol⁻¹, more preferably from 12 000 to 80 000 gmol⁻¹ and especially from 13 000 to 70 000 gmol⁻¹.

It is further preferable when the thermoplastic is present in amounts of not less than 50% by weight, preferably not less than 70% by weight, more preferably not less than 80% by weight and especially not less than 90% by weight, each percentage being based on the weight of the water-soluble polymeric thermoplastic.

Polymeric thermoplastics may comprise plasticizers to improve their processability. This can be of advantage in particular when the polymeric material used for the portion was polyvinyl alcohol or partially hydrolyzed polyvinyl acetate. Useful plasticizers include in particular glycerol, triethanolamine, ethylene glycol, propylene glycol, diethylene glycol, dipropylene glycol, diethanolamine and methyldiethylamine.

It is advantageous when the polymeric thermoplastics comprise plasticizers in amounts not less than >0% by weight, preferably of ≧10% by weight, more preferably of ≧20% by weight and especially of ≧30% by weight, each percentage being based on the weight of the envelope material.

The present invention further provides for the use of one or more fuzz-reducing components where at least 90% of the particles are less than 100 μm in size, preferably less than 50 μm, more preferably less than 20 μm, selected from the group of
a) biological polymers and/or
b) hydrogels and/or
c) synthetic polymers and/or
   selected from the group of silicone emulsions having an average droplet size below 50 μm in a liquid textile-cleaning composition to reduce fuzzing.

The present invention further relates to the use of a present invention's liquid textile-cleaning composition or a present invention's mild-action laundry detergent composition or a present invention's liquid laundry detergent composition or a present invention's nonaqueous liquid laundry detergent composition to reduce fuzzing and/or to reduce pilling of textile fabrics.

The present invention further provides a process for reducing fuzzing of textile fabrics by contacting textile fabrics with a present invention's liquid textile-cleaning composition or a present invention's mild-action laundry detergent composition or a present invention's liquid laundry detergent composition or a present invention's nonaqueous liquid laundry detergent composition in a textile-cleaning operation.

The compositions of the present invention are produced by simply mixing together and stirring the individual components in a manner familiar to one skilled in the art.

### EXAMPLES

Inventive liquid detergent compositions are for example E1 to E3, the compositions of which are reproduced in table 1.

TABLE 1

| Raw material | E1 | E2 | E3 |
|---|---|---|---|
| APG 600^{[a]} | 1.5 | — | — |
| Defoamer^{[b]} | 0.03 | 0.03 | 0.03 |
| Glycerol | 5.0 | — | — |
| Diethylene glycol | 0.5 | — | — |
| 1,2-Propylene glycol | — | 5 | 5 |
| Ethanol | — | 2.5 | 2.3 |
| Texapon N70^{[c]} | 5 | 5 | 5 |
| Dehydol LT7^{[d]} | 12 | 13 | 12 |
| Boric acid | 0.25 | 1 | 1 |
| Sodium formate | 1.5 | — | — |
| Sodium citrate × H₂O | — | 2 | 4 |
| Sodium hydroxide | 0.85 | 0.85 | 1.5 |
| Lauric acid | 3 | 3 | 6 |
| Oleic acid | 1.5 | 1.5 | 2.4 |
| Zinc ricinoleate | 0.5 | 0.5 | — |
| Acusol 820^{[e]} | 0.2 | — | — |
| Dequest 2066^{[f]} | 0.5 | 0.5 | 0.03 |
| Polyvinylpyrrolidone | 0.1 | 0.1 | 0.4 |
| Protease | 0.4 | 0.4 | 0.4 |
| Amylase | — | 0.1 | 0.1 |
| Perfume | 0.7 | 0.7 | 0.7 |
| Arbocel ® BE-600-10^{[g]} | 5.0 | 3.5 | 1.5 |
| Water | ad 100 | ad 100 | ad 100 |

^{[a]}C₁₂₋₁₆ fatty alcohol 1,4-glucoside
^{[b]}dimethylpolysiloxane emulsifier mixture ex Dow
^{[c]}C₁₂₋₁₄ ether sulfate with 2 EO ex Cognis
^{[d]}C₁₂₋₁₈ fatty alcohol + 7 EO ex Cognis
^{[e]}stearyl alcohol-20 EO methacrylate-acrylic acid copolymer ex Cognis
^{[f]}diethylenetriaminepentamethylenephosphonic acid sodium salt ex Monsanto
^{[g]}microcrystalline cellulose (average fiber length: 18 μm) ex Rettenmaier

Table 2 shows the formulation of inventive mild-action laundry detergent composition E4.

TABLE 2

| Raw material | E4 |
|---|---|
| APG 600 | 2.5 |
| Ethylene glycol distearate | 0.3 |
| Ethanol | 0.37 |
| Cetylstearyl alcohol sulfate sodium salt | 0.47 |
| Dehydol LT7 | 14.0 |
| Stepantex VA90^{[h]} | 2.5 |
| Citric acid | 0.05 |
| Cellulase | 0.04 |
| Perfume | 0.7 |
| Cellulon ®^{[k]} | 0.5 |
| Water | ad 100 |

^{[h]}N-methyl-N(2-hydroxyethyl)-N,N-(ditallowacyloxyethyl)-ammonium methosulfate ex Stepan
^{[k]}biotechnologically produced microcellulose ex Kelco

Table 3 depicts an inventive nonaqueous liquid laundry detergent composition E5.

TABLE 3

| Raw material | E5 |
|---|---|
| Glycerol | 1 |
| Ethanol | 3.3 |
| C12-14 Fatty alcohol + EO + PO | 22.5 |
| Dodecylbenzenesulfonic acid isopropylamine salt | 24.5 |
| C₁₂₋₁₈ Fatty acid | 17.5 |
| Dequest 2066 | 0.6 |
| Monoethanolamine | 4.9 |
| Protease | 1 |
| Amylase | 0.2 |
| Cellulase | 0.06 |
| Water | 6 |
| Perfume | 0.25 |
| Dye | + |
| Arbocel ® BE-600-10^{[g]} | 5.0 |
| Propylene glycol | ad 100 |

Inventive compositions E1 to E5 exhibited reduced fuzzing and pilling compared with noninventive compositions without fuzz-reducing component.

As used herein, the articles “a” and “an” are synonymous and used interchangeably with at least one “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

1. A liquid textile-cleaning composition comprising particles of at least one fuzz-reducing component selected from the group consisting of:
a) biological polymers,
b) hydrogels,
c) synthetic polymers and
d) silicone emulsions,
wherein not less than 90% of the particles of a fuzz-reducing component selected from a), b) or c) have a particle size of less than 100 μm, and wherein a fuzz-reducing component selected from d) has an average droplet size below 50 μm.

2. The composition of claim 1, wherein at least 90% of the particles of a fuzz-reducing component selected from a), b) or c) have a particle size of less than 50 μm.

3. The composition of claim 2, wherein at least 90% of the particles of a fuzz-reducing component selected from a), b) or c) have a particle size of less than 20 μm.

4. The composition of claim 1, wherein the fuzz-reducing component comprises a microcrystalline cellulose.

5. The composition of claim 4, wherein the microcrystalline cellulose is produced from a micro-biological fermentation.

6. The composition of claim 1, wherein the hydrogel comprises a polymer selected from the group consisting of agarose, gelatin, curdlan alginates, pectinates, carageenan, and any mixtures thereof.

7. The composition according to claim 1, wherein the fuzz-reducing component comprises a synthetic polymer selected from the group consisting of polyacrylates, polymethacrylates, polyacrylamides, polymethacrylamides, polyurethanes, polyvinylpyrrolidones, polyvinyl alcohols, polyvinyl acetate, acrylic acid-maleic acid copolymers, and any partial hydrolyzates, copolymers, and mixtures thereof.

8. The composition of claim 7, wherein the synthetic polymers are present as hydrogels.

9. The composition of claim 1, comprising 0.005% to 15% by weight of the fuzz-reducing component.

10. The composition of claim 9, comprising 0.01% to 10% by weight of the fuzz-reducing component.

11. The composition of claim 10, comprising 0.1% to 7% by weight of the fuzz-reducing component.

12. The composition of claim 11, comprising 0.5% to 5% by weight of the fuzz-reducing component.

13. The composition of claim 1, further comprising one or more nonionic surfactants.

14. The composition of claim 13, wherein the nonionic surfactants comprise alkoxylated fatty alcohols.

15. The composition of claim 14, wherein the alkoxylated fatty alcohols comprise ethoxylated and/or propoxylated fatty alcohols.

16. The composition of claim 13, further comprising one or more anionic surfactants.

17. The composition of claim 16, wherein the anionic surfactants are selected from the group consisting of fatty alcohol sulfates, fatty alcohol ether sulfates, alkylbenzenesulfonates, soaps, and any mixtures thereof.

18. The composition of claim 16, further comprising one or more complexing agents.

19. The composition of claim 16, further comprising one or more enzymes.

20. The composition of claim 19, wherein the enzymes are selected from the group consisting of proteases, amylases, cellulases, and any mixtures thereof.

21. The composition of claim 19, having a viscosity of 50 to 5000 mPas at 20° C.

22. The composition of claim 21, having a viscosity of 50 to 3000 mPas.

23. The composition of claim 22, having a viscosity of 500 to 1500 mPas.

24. The composition of claim 19, further comprising at least one softener component.

25. The composition of claim 24, wherein the at least one softener component comprises one or more cationic surfactants.

26. The composition of claim 25, wherein the cationic softening surfactants comprise one or more alkylated quaternary ammonium compounds where at least one alkyl chain is interrupted by an ester group and/or amido group.

27. The composition of claim 25, wherein the cationic softening surfactants comprise N-methyl-N(2-hydroxyethyl)-N,N-(ditallowacyloxyethyl)ammonium methosulfate or N-methyl-N(2-hydroxyethyl)-N,N-(dipalmitoylethyl)ammonium methosulfate.

28. The composition of claim 24, having a softener component content of up to 15% by weight.

29. The composition of claim 28, having a softener component content of 0.1% to 10% by weight.

30. The composition of claim 29, having a softener component content of 0.5% to 7% by weight.

31. The composition of claim 30, having a softener component content of 1% to 3% by weight.

32. The composition of claim 19, comprising one or more cellulases.

33. The composition of claim 32, having a cellulase content of 0.005% to 2% by weight.

34. The composition of claim 33, having a cellulase content of 0.01% to 1% by weight.

35. The composition of claim 34, having a cellulase content of 0.02% to 0.5% by weight.

36. The composition of claim 32, further comprising one or more nonionic surfactants selected from the group of alkoxylated fatty alcohols, alkylglycosides, and any mixtures thereof.

37. The composition of claim 32, further comprising one or more nonionic surfactants in amounts up to 30% by weight.

38. The composition of claim 37, having a nonionic surfactant content of 5% to 25% by weight.

39. The composition of claim 38, having a nonionic surfactant content of 10% to 20% by weight.

40. The composition of claim 37, further comprising anionic surfactants in amounts below 10% by weight.

41. The composition of claim 40, having an anionic surfactant content below 5% by weight.

42. The composition of claim 41, having an anionic surfactant content below 1% by weight.

43. The composition of claim 37, further comprising one or more pearl luster agents.

44. The composition of claim 37, further comprising up to 95% by weight of water and/or one or more water-soluble solvents.

45. The composition of claim 44, comprising 20% to 90% by weight of water and/or one or more water-soluble solvents.

46. The composition of claim 45, comprising 50% to 80% by weight of water and/or one or more water-soluble solvents.

47. The composition of claim 16, comprising up to 30% by weight of one or more anionic surfactants.

48. The composition of claim 47, comprising up to 25% by weight of one or more anionic surfactants.

49. The composition of claim 48, comprising 5% to 20% by weight of one or more anionic surfactants.

50. The composition of claim 49, comprising 8% to 15% by weight of one or more anionic surfactants.

51. The composition of claim 47, comprising up to 30% by weight of one or more nonionic surfactants.

52. The composition of claim 51, comprising 5% to 20% by weight of one or more nonionic surfactants.

53. The composition of claim 52, comprising 10% to 15% by weight of one or more nonionic surfactants.

54. The composition of claim 47, further comprising up to 90% by weight of water and/or one or more water-soluble solvents.

55. The composition of claim 54, further comprising 20% to 85% by weight of water and/or one or more water-soluble solvents.

56. The composition of claim 55, further comprising 50% to 80% by weight of water and/or one or more water-soluble solvents.

57. The composition of claim 47, further comprising one or more thickeners.

58. The composition of claim 57, comprising up to 10% by weight of one or more thickeners.

59. The composition of claim 58, comprising up to 5% by weight of one or more thickeners.

60. The composition of claim 59, comprising 0.1% to 1% by weight of one or more thickeners.

61. The composition of claim 47, further comprising one or more enzymes.

62. The composition of claim 61, wherein the enzymes comprise one or more proteases, amylases, or any mixtures thereof.

63. The composition of claim 47, further comprising one or more odor absorbers, dye transfer inhibitors, or any mixtures thereof.

64. A nonaqueous composition according to claim 13, further comprising up to 35% by weight of one or more nonionic surfactants.

65. The nonaqueous composition of claim 64, further comprising 15% to 25% by weight of one or more nonionic surfactants.

66. The nonaqueous composition of claim 64, further comprising up to 60% by weight of one or more anionic surfactants.

67. The nonaqueous composition of claim 66, further comprising 20% to 50% by weight of one or more anionic surfactants.

68. The nonaqueous composition of claim 67, further comprising 30% to 45% by weight of one or more anionic surfactants.

69. The nonaqueous composition of claim 64, having a total surfactant content comprising at least 45% by weight of one or more fatty acid soaps, based on the total surfactant content.

70. The nonaqueous composition of claim 69, having a total surfactant content comprising at least 50% by weight of one or more fatty acid soaps, based on the total surfactant content.

71. The nonaqueous composition of claim 64, further comprising up to 50% by weight of one or more organic solvents.

72. The nonaqueous composition of claim 71, further comprising up to 45% by weight of one or more organic solvents.

73. The nonaqueous composition of claim 72, further comprising 20% to 40% by weight of one or more organic solvents.

74. The nonaqueous composition of claim 64, further comprising one or more enzymes.

75. The nonaqueous composition of claim 74, wherein the enzymes comprise one or more proteases, amylases, cellulases, and any combinations thereof.

76. The nonaqueous composition of claim 64, in the form of a portion enclosed in a wholly or partly water-soluble envelope.

77. The nonaqueous composition of claim 76, wherein the wholly or partly water-soluble envelope comprises one or more materials selected from the group consisting of (optionally partially acetalated) polyvinyl alcohol, polyvinyl alcohol copolymers, polyvinylpyrrolidone, polyethylene oxide, gelatin, cellulose and its derivatives, starch and its derivatives, and any blends, composites, salts, and mixtures thereof.

78. The nonaqueous composition of claim 77, wherein the wholly or partly water-soluble envelope comprises hydroxypropylmethylcellulose and/or polyvinyl alcohol blends.
